(19) United States
(12) Patent Application Publication
(10) Pub. No.: US 2013/0006435 A1
(43) Pub. Date: Jan. 3, 2013

(54) Solar-Powered Apparatus for Wireless Network Control of an Array of Solar Tracking Devices and Systems Based Thereon

(76) Inventors: Javier C. Berrios, Trumbull, CT (US); Brian K. Rosier, Woodbridge, CT (US); Scott C. Mathein, Unionville, CT (US)

(21) Appl. No.: 13/175,309

(22) Filed: Jul. 1, 2011

(51) Int. Cl. G05F 1/46

(52) U.S. Cl. 700/295

(57) ABSTRACT

An apparatus for use in a solar energy facility including a plurality of photovoltaic systems distributed over a local area and a plurality of tracking systems that operate to control orientation of corresponding photovoltaic systems. Each tracking system includes a tracking control unit that employs a wireless network interface for wireless communication over the local area. The apparatus includes a wireless network interface for wireless communication over the local area, a plurality of sensors including a GPS receiver module and an anemometer, a microcontroller operably coupled to the wireless network interface and to the plurality of sensors, a power supply unit (including means for storage of electrical energy) for supplying DC power signals to the apparatus, and at least one photovoltaic cell for converting solar insolation into DC power supply signals that are supplied to the electrical energy storage means of the power supply unit. The microcontroller of the apparatus is programmed to operate in a plurality of modes. The plurality of modes include a low power mode where the microcontroller, wireless network interface and the GPS receiver of the apparatus are automatically operated in respective power saving modes in order to reduce load on the power supply unit of the apparatus. The apparatus can be used in conjunction with a gateway control element to provide for communication to remote monitoring and control stations. The gateway control element can also operate to facilitate tasks on the local wireless network, such as forming the wireless network and multicast propagation of messages.

### BACKGROUND OF THE INVENTION

1. Field of the Invention

The present invention relates to systems that control orientation of photovoltaic systems (PV modules).

2. State of the Art

Photovoltaic systems employ tracking devices that orient the photovoltaic systems with respect the sun over time in order to improve the energy conversion efficiency of the photovoltaic systems. Wired network systems are traditionally used to monitor and operate units that control the tracking devices. However, these wired networks have limitations, such as increased costs associated with network cables that connect the units on the network, reliability problems associated with underground wiring, and grounding issues. These limitations worsen as more tracker devices and networked units are located at the site.

A variation of this wired network topology utilizes the power lines between photovoltaic systems as an information carrier medium. This variation removes the cost of separate network cables. However, it can require a complicated and expensive infrastructure of filters to attenuate noise carried on the power lines, and the variation requires tapping into the high voltage lines which makes installation difficult and dangerous.

More recently, wireless networks have been proposed to monitor and control the tracking devices. An example is illustrated in U.S. Pat. Publ. No. 2009/0188488. This wireless network employs a base station that provides both a network manager and a host gateway. The host gateway communicates with a host computer. The network manager communicates wirelessly with a number of wireless tracking controllers over a Zigbee network.

The software architecture of a Zigbee network comprises three basic levels: a Physical/Data Link level, Zigbee stack level, and Application level. The Physical/Data Link level is provided by the IEEE 802.15.4 standard. It consists of two separate layers; the Physical layer and the Data Link layer. The Physical layer is concerned with the physical transmission medium (radio in this case), exchanging data bits with the medium, as well as exchanging data bits with the layer above (the Data Link layer). The Data Link layer is responsible for addressing; for outgoing data it determines where the data is going, and for incoming data it determines where the data has come from. It is also responsible for assembling data packets or frames to be transmitted and decomposing received frames. The Zigbee stack level provides the glue between the Application level and the Physical Data/Link level. It includes a Network stack layer (typically referred to as the NWK layer) concerned with network structure and routing, and an Application Support stack layer (typically referred to as the APS layer) that is responsible for exchanging data with the Application level above and other services. The Zigbee stack level can also provide for security functions. The Application level embodies the application(s) that run on the node. These applications give the device is functionality.

There are three types of nodes that can exist in a Zigbee network:

Coordinator, Router, and End Device. All Zigbee networks are hierarchical in nature having a root node (the Coordinator node) and a number of nodes connected thereto in a tree structure. The connected nodes of the tree have a parent-child relationship. A number of properties of the network can be pre-configured. The network is initialized by the Coordinator node, at which time these pre-configured properties are taken into account. These properties determine the maximum size (in terms of the maximum number of nodes) and shape of the network, and include Network Depth, Maximum Number of Children, and Number of Child Routers. The depth of a given device in a network is the number of nodes from the root of the network tree (the Coordinator) to the given device. The maximum network depth is then the maximum number of hops from the Coordinator to the most distant device in the network. This determines the overall diameter for the network. Note that a star network has a network depth of 1. Each Router node in the network can have a maximum number of child devices attached to it. These child devices may be either Routers or End Devices. The number of Child Routers specifies the number of children of a Router node can be Routers themselves.

The Zigbee network can have one of three topologies: Star, Tree and Network.

A Star topology consists of a Coordinator and a set of End Devices. Each End Device can communicate only with the Coordinator. To send a message from one End Device to another (or to multicast a message to other End Devices), the message must be sent via the Coordinator node. It is possible to use Router functionality in a Star topology in place of an End Device. However, in this case, the Router is not allowed to have child node attached and so its routing capability is not used.

A Tree topology consists of a Coordinator and a set of Routers and End Devices (its children). A Router may be linked to more Routers and End Devices (its children). This can be continued for a number of levels. End Devices cannot have children, and thus cannot be a parent. In the tree topology, a child can only communicate with its parent (and no other node). A parent can only communicate with its children and with its own parent. In order to send messages from one node to another, the message must travel up the tree to the nearest common ancestor and then down the tree to the destination node (if need be).

A Mesh topology consists of a Coordinator and a set of Routers and End Devices. The structure of the Mesh topology is similar to the Tree topology; however, the communication rules are more flexible in that Router nodes within range of one another can communicate directly with one another.

The way that a message propagates through a Zigbee network depends on the network topology. In most instances, the message needs to pass through one or more intermediate nodes before reaching its final destination. Routing through the network relies on two addresses that are assigned to each node: a 64-bit IEEE (MAC) address that identifies the device (no two devices in the world can have the same IEEE address), and a 16-bit network address that identifies the node in the network and is local to the network (no two nodes in the network can have the same network address). Network addresses are allocated by the parent node (Coordinator or Router) when a node joins the network. Each Zigbee message typically includes the source and destination IEEE address as well as the source and destination network address. The source and destination IEEE addresses are updated as the message travels through the network. The source IEEE address identifies the transmitting node and the destination IEEE addresses identifies the next-hop destination node. The source and destination network addresses do not change as the message travels across the network. The source network address identifies the node that originated the message. The destination network address identifies the node that is the final destination of the message. Message routing can be performed automatically by the Zigbee stack level, without any intervention from the applications running on Router nodes or the Coordinator node. Therefore, routing can be, but not always, transparent to applications. Source routing can also be used. In this configuration, the routing information (i.e., the network addresses) to the destination node is included in the Zigbee message.

Messages conforming to the Zigbee protocol employ a number of predetermined data formats for different layers of the protocol. More specifically, the NWK layer of the Zigbee stack level employs a NWK Layer Frame having one of two frame formats: an NWK data frame type and an NWK command frame type. The NWK data and NWK command frame types include an NWK header and a payload (for carrying data and commands). The NWK header includes the source network address and the destination address for the NWK Layer Frame. The source and destination network address does not change as the NWK Layer Frame travels across the network. The source network address identifies the node that originated the NWK frame. The destination network address identifies the node that is the final destination of the NWK frame. The NWK header can also include the source and destination IEEE address for the NWK frame. The NWK Layer frame is encapsulated in the payload of a MAC Layer Frame as described below.

The Data Link layer (also commonly referred to as the “Mac Layer”) of the Physical/Data Link level employs a Mac Layer Frame having one of four frame structures: a beacon frame type, a data frame type, an acknowledgement frame type, and a MAC command frame type. The beacon, data and MAC command frame types include addressing fields and a payload (for encapsulating a NWK Layer Frame). The addressing fields typically include source and destination IEEE addresses for the Mac Layer frame, which are updated as the encapsulated NWK Layer Frame travels through the network. The source IEEE address identifies the transmitting node for the MAC layer frame, and the destination IEEE address identifies the next-hop destination node for the MAC layer frame. The MAC Layer frame is encapsulated in the payload of a PHY Layer packet as described below.

The Physical Layer of the Physical/Data Link level employs a packet structure (referred to herein as the “PHY Layer packet”) defined by the IEEE 802.15.4 standard that includes the following fields:
32-bit preamble for synchronization;
8-bit start-of-packet delimiter;
8-bit PHY head specifying the length of the PHY service data unit (PSDU); and
a variable length (up to 127 bytes) PSDU of payload for encapsulating a Mac Layer Frame.

The Zigbee stack level supports the routing of messages over the network. Routing between Routers (including the Coordinator) can be organized using the Ad-hoc On-Demand Distance Vectoring algorithm. The routing table for each Router (including the Coordinator) is built using broadcast requests to other Routers. One a route is set up, it is used as long as it functions properly Source routing can also be used. In this scheme, gateway router(s) broadcast a many-to-one router request packet. All routers that receive this broadcast, record the shortest path to the sender (gateway) into their routing table and send it back to the gateway router as a route reply packet. After this, the gateway router transmits data to a destination node utilizing a special format of packets with the source routing flag enables. This type of packet includes the entire route information (the network addresses) to the destination node encapsulated inside the packet.

The Zigbee stack level can also support the broadcast (multicast) of messages to nodes on the network. Broadcasts come in three flavors that are dictated by predetermined destination network addresses as follows:

an NWK Layer Frame with a destination network address of 0xffff is broadcast to all nodes on the network; this broadcast is propagated by all Routers and the Coordinator of the network, which hold the message for delivery to sleeping child nodes;

an NWK Layer Frame with a destination network address of 0xfffd is broadcast to all non-sleeping nodes on the network; this broadcast is propagated by all Routers and the Coordinator of the network, which do not hold the message for delivery to any sleeping child node;
an NWK Layer Frame with a destination network address of 0xfffc is broadcast to all Routers and the Coordinator of the network.

The Application level can support a mechanism for binding together nodes such that output data from one node can be automatically routed to one or more paired nodes. This binding mechanism creates a logical link between the paired nodes. This binding mechanism utilizes profiles and clusters that are supported on the nodes. A profile is identified by a profile ID. It relates to a particular application and contains descriptions of the type of devices and interfaces which are needed for that particular application. The profile also specifies the information that a device can generate as output and can use as input, together with the format this information takes. This information is referred to as attributes. Such attributes are grouped together into clusters. A cluster is identified by a cluster ID and only has a meaning for a particular profile (as identified by a profile ID). Binding table entries are used to enforce the logical links between nodes. The binding table entries can represent a number of binding configurations that can be set by the system design. For a one-to-one binding configuration, one endpoint is bound to one (and only one) other endpoint. For a one-to many binding configuration, one ne endpoint is bound to a number of endpoints. The binding table entries can be stored either on the Coordinator node or locally on the node generating the source output cluster (source node). Depending on where the binding information is stored, transmission of the cluster information from the source node to the destination node is direct or indirect.

In the case of a direct binding, the binding table entries are stored on the source node. Therefore, when new output cluster information is generated on the source node, the following operations occur:

all binding table entries containing the profile ID and cluster ID of the output cluster information are found locally on the source node;

for each of these matching binding table entries, the source node generates a message containing the new cluster information; and

for each message generated, the source node adds the destination network address of the paired endpoint and other endpoint information to the message based upon the corresponding binding table entry, and the message is routed over the network to the paired endpoint using the most appropriate path in the network.

In the case of an indirect binding, the binding table entries are stored on the Coordinator node. Therefore, when new output cluster information is generated on the source node, the following operations occur:

a message containing the new information (including profile ID and cluster ID) together with the source application address (network address and endpoint) is sent to the Coordinator node;

the Coordinator node identifies all binding table entries corresponding to the profile ID, cluster ID and source application address, and generates a message replicating the cluster information it received for each entry found; and

for each message, the Coordinator node adds the destination network address of the paired endpoint and other endpoint information to the message based upon the corresponding binding table entry, and the message is routed over the network to the paired endpoint using the most appropriate path in the network.

The main task of the Coordinator node is system initialization (starting the network and allowing child nodes to join the network). It can also provide message routing, security management and other services. It also can act as a bridge to other networks. At least one router node is required for Tree and Mesh topologies as described above. The main task of the Router node is relaying messages from one node to another and allowing child nodes to connect to it. The Router node is also responsible for receiving and storing messages intended for its children. It can also manage local address allocation and deallocation. It can be used to extend network coverage.

In U.S. Pat. Publ. No. 2009/0188488, sensors and actuators are interfaced to each wireless tracking controller. These sensors and actuators are used to control operation of the tracking controllers in mechanically driving the tracking devices interfaced thereto. However, this wireless network fails to provide flexibility in locating sensors that acquire data that can be used in the control operations carried out by the number of wireless tracking controllers.

### SUMMARY OF THE INVENTION

The problems of the prior art are solved by the present invention, which includes an apparatus for use in a solar energy facility including a plurality of photovoltaic systems distributed over a local area and a plurality of tracking systems corresponding to the photovoltaic systems. The tracking systems operate to orient the corresponding photovoltaic systems. Each tracking system includes a tracking control unit that employs a wireless network interface for wireless communication over the local area. The apparatus includes a wireless network interface for wireless communication over the local area, a plurality of sensors including a GPS receiver module and an anemometer, a microcontroller operably coupled to the wireless network interface and to the plurality of sensors, a power supply unit (including means for storage of electrical energy) for supplying DC power signals to the apparatus, and at least one photovoltaic cell for converting solar insolation into DC power supply signals that are supplied to the electrical energy storage means of the power supply unit. The microcontroller of the apparatus is programmed to operate in a plurality of modes. The plurality of modes include a low power mode where the microcontroller, wireless network interface and the GPS receiver of the apparatus are automatically operated in respective power saving modes in order to reduce load on the power supply unit of the apparatus. The automatic power management operations carried out by the microcontroller together with the rechargeable photovoltaic-based power supply unit of the apparatus enable the apparatus to operate without the supply of mains electricity. This feature allows for flexibility in positioning the apparatus, while providing for effecting communication of acquired sensor data (GPS time and location, wind speed, a wind alarm flag, temperature, and/or other acquired data) to the local tracker control units and remote monitoring systems.

In an illustrative embodiment, the microcontroller of the apparatus is programmed to monitor wind speed and selectively raise a wind speed alarm based on output of the anemometer in the low power mode, and perform a predetermined sequence of operations in the event that the status of the wind speed alarm provides an indication that the wind speed alarm has been raised. The predetermined sequence of operations include changing the mode of operation of the wireless network interface of the apparatus from its power saving mode into an active state (to allow for wireless communication over the local area), and using the wireless network interface to wirelessly communicate a message over the local area that conveys an indication that the wind speed alarm has been raised by the apparatus. After completing the predetermined sequence of operations, the microcontroller controls the wireless network interface of the apparatus to return back to its power savings mode.

In another illustrative embodiment, the microcontroller of the apparatus is programmed to monitor status of a first time alarm (e.g., raised every hour), and perform a predetermined sequence of operations in the event that the status of the first time alarm provides an indication that the first time alarm has been raised. The predetermined sequence of operations includes changing the mode of operation of the wireless network interface of the apparatus from its power saving mode into an active state (to allow for wireless communication over the local area), and using the wireless network interface to wirelessly communicate a predetermined message over the local area to provide an indication that the wireless network interface of the apparatus is active and ready for communication. After completing the predetermined sequence of operations, the microcontroller controls the wireless network interface of the apparatus to return back to its power savings mode.

In yet another illustrative embodiment of the invention, the microcontroller of the apparatus is programmed to maintain a real time clock, monitor status of a second time alarm based upon the real time clock (e.g., raised every 12 hours), and perform a predetermined sequence of operations in the event that the status of the second time alarm provides an indication that the second time alarm has been raised. The predetermined sequence of operations includes changing the mode of operation of the GPS receiver from its reduced power mode to an active state (to allow for deriving time from RF signals received from GPS satellites), reading time from the GPS receiver, and updating the real time clock maintained by the microcontroller based upon the time read from the GPS receiver in order to compensate for drift of the real time clock. After completing the predetermined sequence of operations, the microcontroller controls the GPS receiver to return back to its power savings mode.

In yet another exemplary embodiment, the wireless network interfaces of the apparatus and the tracker control units supports wireless communication over a wireless mesh network (preferably a Zigbee Network). In this configuration, the wireless network interface of the apparatus is preferably (but not limited to) configured to operate as an end device of the Zigbee wireless network.

Furthermore, the wireless network interface of the apparatus is preferably configured to support multi-hop routing of a respective message to the tracking control units, wherein the multi-hop routing is carried out in a transparent manner with respect to the operation of the wireless network interface of the apparatus. The respective message can carry information used in the control operations for all of the tracking control units, such as a wind alarm generated by the microcontroller (to trigger stow operations at the tracker devices), time maintained by the real time clock of the microcontroller (this accurate time is used for control of the tracker devices), and location derived from the GPS receiver (location is also used for tracking control of the tracker devices).

The apparatus can be used in conjunction with a wireless gateway node (referred to herein as a network control unit (NCU)) to provide for communication to remote monitoring and control stations. The NCU can also operate to facilitate tasks on the local wireless network, such as forming the wireless network and multi-hop routing of messages on the wireless network. The network is preferably configured with using a source routing method, whereas the NCU sends messages to tracker control units following pre-established routes. This avoids some of the overhead required for a fully meshed network.

### BRIEF DESCRIPTION OF THE DRAWINGS

FIG. 1 is a schematic diagram that illustrates an exemplary photovoltaic (PV) power generation system that embodies the present invention.

FIG. 2 is a functional block diagram of an exemplary embodiment of a tracking control unit of FIG. 1 together with a corresponding tracker device and PV system.

FIG. 3A is a functional block diagram of an exemplary embodiment of the network control unit of FIG. 1.

FIG. 3B is a functional block diagram of hardware resources and software resources embodied by the processing platform of the network control unit of FIG. 3A.

FIG. 4A is a perspective view of an exemplary embodiment of the sensor unit of FIG. 1.

FIG. 4B is a functional block diagram of the exemplary sensor unit of FIG. 4A.

FIG. 5 is a functional block diagram of the power supply unit of the sensor unit of FIG. 4A.

FIG. 6A is a state diagram illustrating operational modes carried out by the microcontroller of the exemplary sensor unit of FIG. 4A.

FIGS. 6B-6D are diagrams illustrating operations carried out by the microcontroller in servicing three different alarms raised in the SLEEP Mode of FIG. 4A.

FIG. 7 is a flow chart illustrating exemplary operations carried out by the network control unit of FIG. 1 in communicating with sensor unit as well as the tracker control units and remote system(s) during the alarm conditions of FIGS. 6B and 6C.

### DETAILED DESCRIPTION OF THE PREFERRED EMBODIMENTS

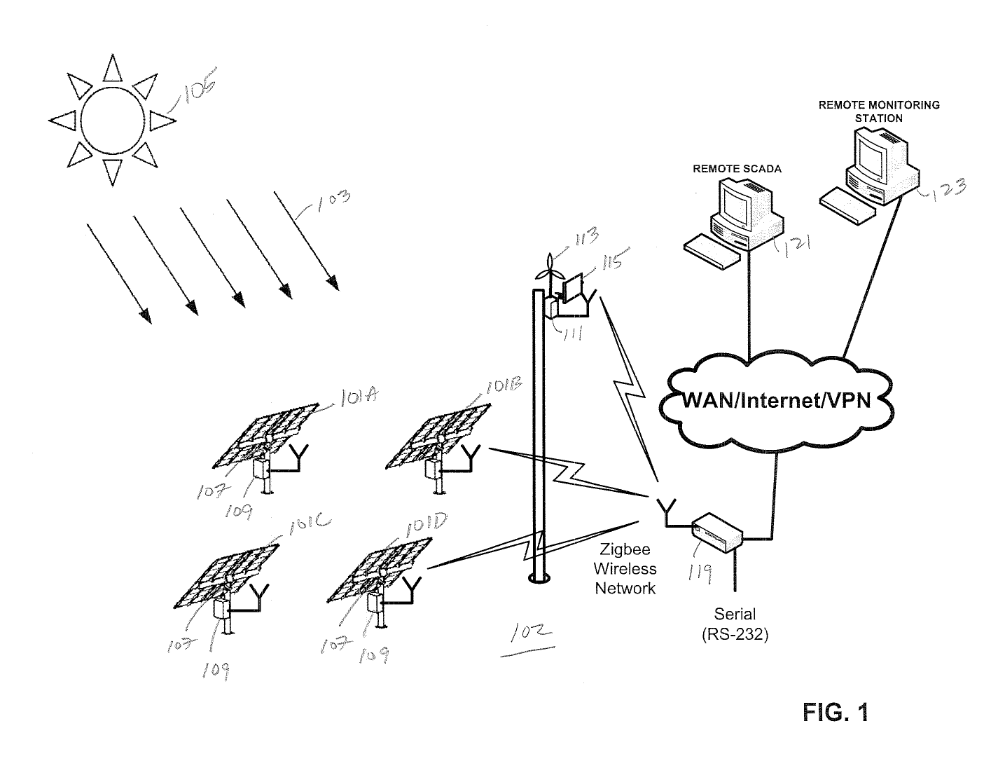

FIG. 1 illustrates an exemplary photovoltaic (PV) power generation system 100 that embodies the present invention. The PV power generation system 100 includes any array of PV systems (for example, four PV modules 101A, 101B, 101C, 101D) that are distributed over a local area 102 of an installation site. Each PV system can be realized by one or more PV modules that include an array of PV cells (typically silicon or polycrystalline silicon PV cells). The PV systems can be supported by masts that are secured to the ground as shown. Alternatively, the PV systems can be mounted on a rooftop of a building, dwelling or other suitable support structure. The PV systems (101A, 101B, 101C, 101D) convert insolation 103 from the sun 105 into DC electrical energy. For some applications, the DC electrical energy generated by the PV systems (101A, 101B, 101C, 101D) is supplied via electrical conductors (not shown) to one or more charge controllers located at the installation site. The charge controller stores the DC electrical energy in a bank of batteries located at the installation site as is well known. The DC output of the bank of batteries (and/or the DC output of the PV systems) can be input to an inverter located at the installation site. The inverter converts the DC input to AC power supply signals. In grid-tied applications, the AC power supply signals generated by the inverter can be supplied to the mains power grid. The AC power signals generated by the inverter can also be used as power supply signals for local electrical equipment (including the local components of the distributed tracker control system described below) as well as mains electricity for buildings, dwellings and other structures located at the installation site. In large scale PV power plant applications, the charge controller and battery bank can be omitted. In these applications, the DC output of the PV systems is supplied to an inverter located at the installation site as is well known. The inverter converts the DC input to AC power signals, which are typically input to a step-up transformer for conversion to HV power signals that are distributed over high voltage transmission lines of an electrical power distribution network.

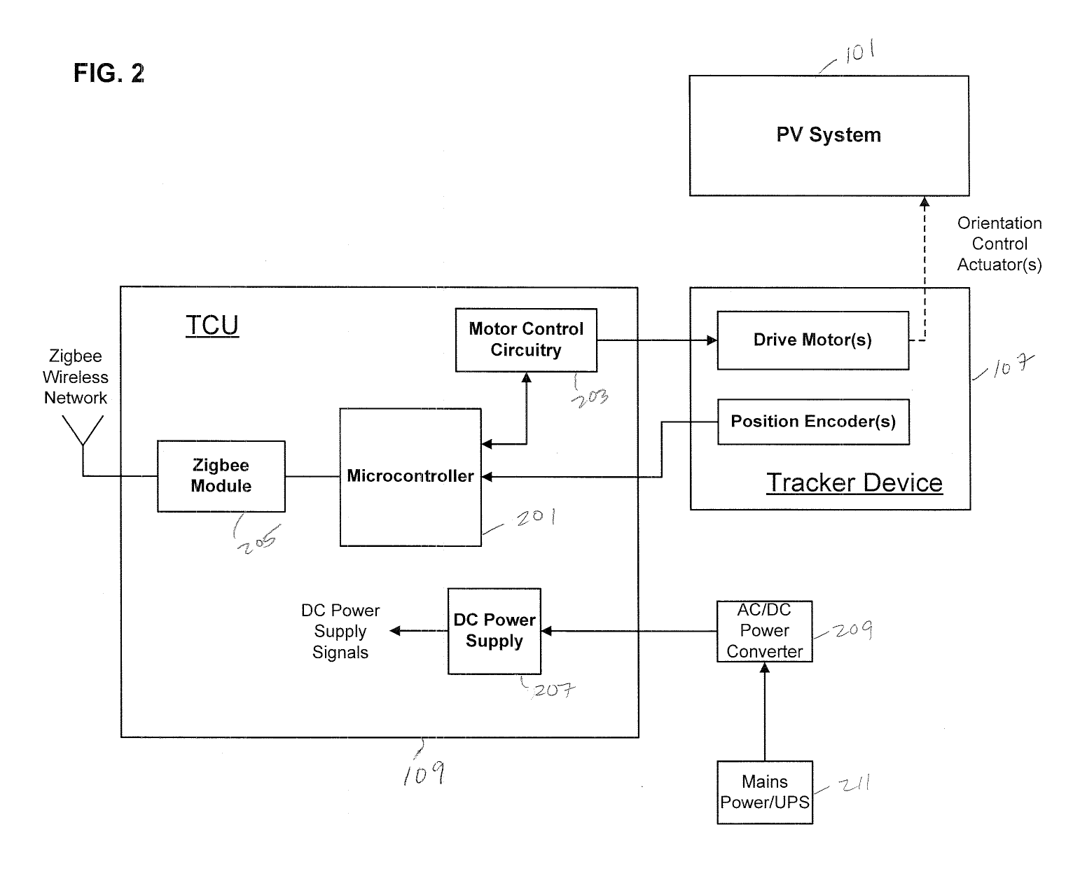

The PV systems (101A, 101B, 101C, 101D) are most efficient when aligned in a perpendicular direction relative to the insolation. However, due to the change of the tilt of the earth relative to the sun over the seasons (winter, spring, summer, and fall), the direction of the insolation changes over time. Thus, in order to improve the overall DC energy generation of the PV systems, each respective PV system (101) employs a tracking device 107 (e.g., drive motor(s), position encoder(s), control actuator(s), etc.) that is capable of adjusting the orientation of the respective PV system 101 under electronic control of a corresponding tracker control unit (TCU) 109 as shown schematically in FIG. 2. The TCU 109 and corresponding tracker device 107 cooperate to adjust orientation of the respective PV system 101 over time during periods of daylight in order to improve the efficiency of the respective PV system 101.

The TCU 109 and corresponding tracker device 107 can rotate the respective PV system 101 about a single rotational axis (typically referred to as a single axis solar tracking system). The single rotational axis can extend parallel to the ground or support surface. This configuration is commonly referred to as a horizontal single axis tracker or horizontal tracker. In this configuration, the face of the respective PV system 101 is typically oriented parallel to the axis of rotation, and as the PV system moves, it sweeps a cylinder that is rotationally symmetric around the axis of rotation. Alternatively, the single rotational axis can extend vertically with respect the ground or support surface. This configuration is commonly referred to as vertical single axis tracker of vertical tracker. In this configuration, the face of the PV system is typically oriented at an angle with respect to the axis of rotation, and as the PV system moves, it sweeps a cone that is rotationally symmetric around the axis of rotation. In yet another deign, the single axis of rotation can lie between the horizontal and vertical orientation with respect to ground or the support surface. This configuration is typically referred to as a tilted single axis tracker or tilted tracker. In this configuration, the face of the PV system is typically oriented parallel to the axis of rotation, and as the PV system moves, it sweeps a cylinder that is rotationally symmetric around the axis of rotation. The tilt angle of the axis of rotation is often limited to reduce the wind profile and decrease the height of the elevated end of the PV system relative to the ground or support surface.

Alternatively, the TCU 109 and corresponding tracker device 107 can adjust the orientation of the respective PV system 101 about two degrees of freedom that act as axes of rotation (typically referred to as a dual axis solar tracking system). These axes are typically normal to one another. The axis that is fixed with respect to the ground or support surface can be considered a primary axis. The axis that is referenced to the primary axis can be considered a secondary axis. There are several common implementations of dual axis solar tracking systems. They are classified by the orientation of their primary axes with respect to the ground or support surface. One common dual axis design typically referred to as a Tip-Tilt Dual Axis Tracker employs a primary axis horizontal to the ground or support surface. The secondary axis is then typically normal to the primary axis. Another common dual axis design typically referred to as an Azimuth-Altitude Dual Axis Tracker employs its primary axis vertical to the ground or support surface. The secondary axis is then typically normal to the primary axis. The PV system is typically mounted to platform which is supported by a base. The base s typically rotated about the primary vertical axis by a vertical pivot shaft or horizontal ring mount. The platform is typically rotated about the secondary axis by a horizontal elevation pivot mounted upon the base.

Alternatively, the TCU 109 and corresponding tracker device 107 can adjust the orientation of the respective PV system 101 utilizing other suitable single, dual, and hybrid designs.

The local group of TCUs (109A, 109B, 109C, 109D) each include a wireless communication interface that supports wireless communication over the local area 102 utilizing an industry standard wireless communication protocol. In the preferred embodiment, the wireless communication interfaces of the TCUs support wireless communication based on the IEEE 802.15.4-2003 protocol such as a Zigbee as shown in FIGS. 1 and 2. Zigbee is a protocol defined by the Zigbee Alliance, which is a group of companies that work together in creating wireless network standards for low-powered digital radios. The first version of the Zigbee protocol was introduced in 2004. Since then, three new versions of the Zigbee protocol have been released: Zigbee 2006, Zigbee, 2007 and Zigbee Pro. Zigbee 2006, Zigbee 2007 and Zigbee Pro support multicasting. Zigbee Pro utilizes stochastic addressing and further supports source routing and enhanced security. All of these versions and subsequent variations are referred to herein as the “Zigbee protocol” or “Zigbee”. A network that practices the Zigbee protocol is referred to as a Zigbee network.

In accordance with the present invention, a sensor unit 111 is provided that is located in the local area 102 of the installation site. The sensor unit 111 includes an integral wireless communication interface that provides for wireless communication over the local area 102 utilizing an industry standard wireless communication protocol that is compatible with the wireless communication interfaces of the TCUs. In the preferred embodiment, the wireless communication interface of the sensor unit 111 supports wireless communication based on the IEEE 802.15.4-2003 protocol such as a Zigbee as shown in FIG. 1. The wireless communication interface of the sensor unit 111 can be controlled electronically to operate in one or more power saving states (with reduced power consumption).

The sensor unit 111 also includes an integral Global Positioning System (GPS) receiver module that can be controlled to operate in one or more power saving modes (with reduced power consumption). The GPS receiver module derives an accurate measure of time as well as the location (latitude and longitude coordinates) of the installation site as is well known in the electrical arts.

The sensor unit 111 also includes an electrical interface to an external anemometer 113. The anemometer 113 can be a cup-type anemometer, a windmill-type (or propeller) anemometer, a hot-wire anemometer, a laser doppler anemometer, a sonic anemometer or other suitable anemometer device. The sensor unit 111 and the external anemometer 113 cooperate to measure wind speed in the local area 102 of the installation site, to generate digital data representative of the measured wind speed, and ascertain whether the measured wind speed exceeds a predetermined threshold for raising a wind speed alarm. The sensor unit 111 and the anemometer 113 might also cooperate to measure wind direction in the local area 102 of the installation site, and to generate digital data representative of the measured direction.

The sensor unit 111 can also interface to other sensors for acquiring data that is used in the photovoltaic electrical generation process (or other related processes) carried out at the installation site. Such sensors can include a temperature sensor for monitoring the temperature at the installation site, a pressure sensor for monitoring atmospheric pressure for weather monitoring, a humidity sensor (Hygrometer) for monitoring the moisture content in the environmental air, or humidity, and possibly others.

The sensor unit 111 also includes an internal power supply unit with rechargeable electrical energy storage means (i.e., capacitor(s) or rechargeable battery(ies)) that is charged by an external solar cell 115. Optionally, an external battery backup can be used to recharge the electrical energy storage means of the power supply unit in the event that no solar input in available (e.g., at night). During much of the time during its operation, the sensor unit 111 operates in a low power mode in order to reduce the power load on the electrical energy storage means of the power supply unit, and thus provide for effective operation based on solar input even during extended periods of bad weather with limited solar input during daylight hours. In the low power mode of the sensor unit 111, the GPS receiver module and wireless communication interface of the sensor unit 111 are operated in their respective power saving states in order to reduce the power load on the electrical energy storage means of the power supply unit of the sensor unit 111.

In the preferred embodiment as shown in FIG. 1, the sensor unit 111 is mounted together with the external anemometer 113 and the external solar panel 115 on a pole 117 above the ground or other support surface. The position of the pole 117, the anemometer 113, and the solar panel 115 should be selected to avoid local obstructions to wind flow and maximize the amount of sunlight received by the solar panel 115.

In the preferred embodiment, the wireless communication interfaces of the sensor unit 111 and the local group of TCUs support the Zigbee protocol.

The present invention also preferably employs a distributed system to communicate with and control the local group of TCUs (109A, 109B, 109C, 109D) and the sensor unit 111. The distributed system includes a gateway element 119 (referred to herein as network control unit or NCU) that is located in the local area 102 of the installation site. The distributed system also preferably includes a computer system (or network of computer systems) 121 (referred to herein as a SCADA system) that is located remotely from the installation site with functionality for monitoring and control of the photovoltaic electrical generation processes carried out at the installation site. The distributed system can also include a computer system (or network of computer systems) 123 that is located remotely from the installation site with functionality for remote monitoring and control of the TCUs (109A, 109B, 109C, 109D), the sensor unit 111, and the NCU 119. The NCU 119 communicates on one side to the local group of TCUs (109A, 109B, 109C, 109D) and the sensor unit 111 via a wireless communication interface, and communicates on the other side to the remote SCADA system 121 and/or remote management station(s) 123 via a wide area network interface. The wireless communication interface of the NCU 119 supports wireless communication over the local area 102 of the installation site utilizing an industry standard wireless communication protocol that is compatible with the wireless communication interfaces of the TCUs and the sensor unit 111. In the preferred embodiment, the wireless communication interface of the NCU 119 supports wireless communication based on the IEEE 802.15.4-2003 protocol such as a Zigbee as shown in FIG. 1. The wide area network interface of the NCU 119 supports packet communication over a wide area network (such as the Internet or a VPN) using standard networking protocols. In the preferred embodiment, the wide area network interface of the NCU 119 supports wired communication over the wide area network using the TCPIP protocol and the IEEE 802.3 (Ethernet) protocol. Alternatively, the wide area network interface of the NCU can support wireless communication over the wide area network using the TCPIP protocol and a standard wireless data packet communication protocol such as WIMAX, UMTS, GPRS, and EDGE, and CDMA2000.

In the preferred embodiment, the sensor unit 111 is configured as a Zigbee End Device, the local group of TCUs are configured as Zigbee Routers or End Devices, and the NCU 119 is configured as the Coordinator node on the Zigbee network. The topology of the Zigbee network can be a Star topology, Tree topology or Mesh topology as desired. In this configuration, the Coordinator NCU 119 can support propagation of information from the sensor unit 111 to the local group of TCUs (109A, 109B, 109C, 109D) utilizing the message propagation functionality supported by the Zigbee network. More specifically, the Coordinator NCU 119 can store routing information (e.g., network addresses and IEEE addresses) for the local group of TCUs (109A, 109B, 109C, 109D) on the Zigbee network. The Coordinator NCU 119 can receive information from the sensor unit 111 and propagate the information as part of unicast messages directed to the local group of TCUs (109A, 109B, 109C, 109D) utilizing the stored routing information for the local group of TCUs. The unicast messages can employ source routing information to avoid the overhead of a fully meshed network. Alternatively, the Coordinator NCU 119 can propagate the information to the local group of TCUs (109A, 109B, 109C, 109D) utilizing logical connections defined by bindings supported by the Application level of the Zigbee network as described above. In another alternative, the Coordinator NCU 119 can propagate the information to the local group of TCUs (109A, 109B, 109C, 109D) utilizing the broadcast (multicast) mechanism to its child nodes by employing a destination network address of 0xfffd (or 0xfffd) as described above. Router nodes that receive the broadcast can also repeat the broadcast. In this manner, the information propagates to the local group of TCUs (109A, 109B, 109C, 109D). Such communication preferably provides for propagation of the time as well as location measured by the integral GPS module of the sensor unit 111 to the local group of TCUs (109A, 109B, 109C, 109D) for tracking purposes. Such communication also preferably provides for propagation of a wind speed alarm message to the local group of TCUs (109A, 109B, 109C, 109D) upon detection of high wind speed alarm condition at the sensor unit 111 as described above.

As a gateway element, the NCU 119 operates to join together the two networks (the local wireless communication network and the wide area network) to allow for communication between the devices that are coupled to these disparate networks. Such communication can provide the remote system (SCADA system 121 or remote management station 123) access to the local group of TCUs (109A, 109B, 109C, 109D) and the sensor unit 111 for a variety of purposes, such as:
communication of control commands between the remote system and the local group of TCUs (109A, 109B, 109C, 109D) with the NCU 119 acting as a gateway element therebetween, where the control commands provide for remote configuration and control of the TCUs by the remote system; such remote configuration can involve accessing and setting operational parameters used by the TCUs (e.g., parameters for alarms such as tracker malfunction or PV system malfunction generated by a respective TCU, and parameters for tracker safe position(s) used in the event of a wind alarm), accessing and setting parameters for the wireless communication interface of the respective TCU (such as channel number, PAN ID, Network Address for the TCU, Endpoint Address for a control application within the TCU, and Node type (Router or End Device) for a Zigbee wireless network), and enabling/disabling/clearing any status flags or operational meters (e.g., an energy meter that monitors the energy produced by the PV system whose orientation is controlled by the respective TCU); such remote control can involve adjusting operational parameters of the respective TCU (e.g., parameters that dictate the orientation of the PV system controlled the respective TCU), and communication of polling requests and/or alarms from the remote system to the respective TCU;
communication of tracker data (e.g., status parameters and other data maintained by a respective TCU) from the local group of TCUs (109A, 109B, 109C, 109D) to the remote system with the NCU 119 acting as a gateway element therebetween;
communication of alarms (e.g., tracker malfunction) from the local group of TCUs (109A, 109B, 109C, 109D) to the remote system with the NCU 119 acting as a gateway element therebetween;
communication of control commands between the remote system and the NCU 119 for remote configuration of the NCU 119 by the remote system; such remote configuration can include accessing and updating parameters for the wide area network interface of the NCU (such as the TCPIP address, security-related settings, i.e., a user name and password for authentication, firewall-related settings, and VPN-related settings) as well as accessing and updating parameters for the wireless communication network interface of the NCU (such as channel number, PAN ID, Network Address for the NCU, Endpoint Address for a control application within the NCU, Node type (Coordinator), and a routing table for a Zigbee wireless network);
communication of control commands between the remote system and the sensor unit 111 with the NCU 119 acting as a gateway element therebetween, where the control commands provide for remote configuration and control of the sensor unit 111 by the remote system; such remote configuration can involve accessing and setting parameters for the wireless communication interface of the sensor unit 111 (such as channel number, PAN ID, Network Address for the sensor unit 111, Endpoint Address for a control application within the sensor unit, and Node type (End Device) for a Zigbee wireless network), and communication of polling requests from the remote system to the sensor unit;
communication of data (such as location, time and wind speed) measured by the sensor unit 111 from the sensor unit 111 to the remote system with the NCU 119 acting as a gateway element therebetween; such data can be communicated from the sensor unit 111 to the remote system for monitoring purposes; and
communication of alarm conditions (such as a wind speed alarm condition) from the sensor unit 111 to the remote system with the NCU 119 acting as a gateway element therebetween; such alarms can be communicated from the sensor unit 111 to the remote system for monitoring purposes.

In the preferred embodiment where the NCU 119, the local group of TCUs (109A, 109B, 109C, 109D) and the sensor unit 111 support wireless communication over a Zigbee network, the remote system(s) (the SCADA system 121 and/or or the remote management station 123) preferably transmits a message to a respective TCU by encapsulating information (including an identifier or address for the respective TCU) as part of TCP/IP packet data addressed to the NCU 119. The TCP/IP packet data is routed over the wide area network and received by the NCU 119. The NCU 119 extracts the information encapsulated in the received packet data, builds a Zigbee frame (NWK Layer Frame) that encapsulates the extracted information in a format suitable for consumption by the respective TCU (with a destination network address corresponding to the respective TCU as referred to by the identifier or address extracted by the NCU), and then routes the Zigbee frame over the Zigbee network using the most appropriate path in the network.

The respective TCU preferably transmits a message to the remote system (the SCADA system 121 and/or the remote management station 123) by encapsulating information (including an identifier or address for the remote system 121) as part of a Zigbee frame addressed to the NCU 119. The NCU 119 receives the Zigbee frame, extracts the information encapsulated therein, generates TCP/IP packet data that encapsulates the extracted information in a format suitable for consumption by the remote system (with a destination address corresponding to the remote system as referred to by the identifier or address extracted by the NCU), and then routes the TCP/IP packet data over the wide area network for delivery to the remote system and processing thereon.

The remote system (SCADA system 121 or the remote management station 123) preferably transmits a message to the sensor unit 111 by encapsulating information (including an identifier or address for the sensor unit 111) as part of TCP/IP packet data addressed to the NCU 119. The TCP/IP packet data is routed over the wide area network and received by the NCU 119. The NCU 119 extracts the information encapsulated in the received packet data, builds a Zigbee frame that encapsulates the extracted information in a format suitable for consumption by the sensor unit 111 (with a destination network address corresponding to the sensor unit 111 as referred to by the identifier or address extracted by the NCU 119), and routes the Zigbee frame over the Zigbee network using the most appropriate path in the network. In the event that the sensor unit 111 is a direct child of the NCU 119, the NCU 119 is responsible for storing the Zigbee frame for delivery to the sensor unit 111 when the sensor unit 111 is active. Alternatively, where the sensor unit 111 is a direct child of another node, such parent can be responsible for storing the Zigbee frame for delivery to the sensor unit 111 when the sensor unit 111 is active.

The sensor unit 111 preferably transmits a message to the remote system (SCADA system 121 or the remote management station 123) by encapsulating information (including an identifier or address for the remote system) as part of a Zigbee frame addressed to the NCU 119. The NCU 119 receives the frame, extracts the information encapsulated therein, generates TCP/IP packet data that encapsulates the extracted information in a format suitable for consumption by the remote system (with a destination address corresponding to the remote system as referred to by the identifier or address extracted by the NCU 119), and then routes the TCP/IP packet data over the wide area network for delivery to the remote system and processing thereon.

The NCU 119 preferably incorporates an HTTP server (and possibly other web services logic) that allows for interaction between the NCU 119 and the remote system(s) (SCADA system 121 and/or the remote management station(s) 123) to provide for remote access to status information maintained by the NCU 119 as well for remote configuration of the NCU 119 by the remote system(s). The status information maintained by the NCU 119 can include GPS time and location, a wind alarm flag, temperature, voltage level of the power supply unit of the sensor unit and other acquired data communicated from the sensor unit 111. The status information can also include other data communicated from the local group of TCUs (109A, 109B, 109C, 109D) to the NCU 119 over the local wireless network (e.g., the Zigbee network). The remote configuration of the NCU 119 can include accessing and updating parameters for the wide area network interface of the NCU 119 (such as the TCPIP address, security-related settings, i.e., a user name and password for authentication, firewall-related settings, and VPN-related settings) as well as accessing and updating parameters for the wireless communication network interface of the NCU 119 (such as channel number, PAN ID, Network Address for the NCU, Endpoint Address for a control application within the NCU, Node type (Coordinator), and a routing table for a Zigbee wireless network). In this configuration, the remote system employs a web browser to access the status information and configuration parameters provided by the HTTP server of the NCU 119. The NCU 119 can also incorporate telnet services to provide for remote configuration of the NCU 119 by the remote system(s). In this configuration, the remote system employs a command line interface (or other suitable interface) to access the configuration functionality provided by the telnet services of the NCU 119. The telnet services can also be made available by a serial port of the NCU 119 for local configuration. Other suitable services (such as an XML-based remote command interface, SNMP interface, and serialTCP) can be used to provide for remote (and/or local) configuration of the NCU 119 by the remote system(s).

FIG. 2 illustrates an exemplary embodiment of the TCU 109 of FIG. 1, including a microcontroller 201 that interfaces to motor control circuitry 203, a wireless communication interface 205, and one or more position encoder(s) of the tracker device 107. The TCU 109 also includes a DC power supply circuit 209. These elements are preferably mounted on one or more printed circuit boards (not shown) with interconnections therebetween as is standard in the electronic arts, with the circuit board(s) supported and enclosed within the housing. Under control of a tracking control program executing the microcontroller 201, the motor control circuitry 203 supplies electrical signals that drive one or more drive motor(s) of the tracker device 107. The position encoder(s) provide feedback for control of the drive motors to adjust the orientation of the PV system 101 (as controlled by the control actuators that couple the drive motor(s) to the PV system 101). The wireless communication interface 205 provides for wireless communication over the local area 102 utilizing an industry standard wireless communication protocol. In the preferred embodiment, the wireless communication interface 205 supports wireless communication based on the IEEE 802.15.4-2003 protocol such as a Zigbee. The wireless communication interface 205 provides for communication between the local group of TCUs, the sensor unit 111 and the NCU 119 as described above. The DC power supply unit 207 performs DC/DC power conversion that converts DC power signals generated by an external AC/DC power converter 209 into regulated DC power signals at the levels required for supply to the active components of the unit 109. The AC/DC power converter 209 (e.g., a switched-mode power supply) is supplied with AC power signals from Mains power (or an Uninterruptable Power Supply) 211 and converts such AC power signals into DC power signals suitable for input to the DC power supply unit 207.

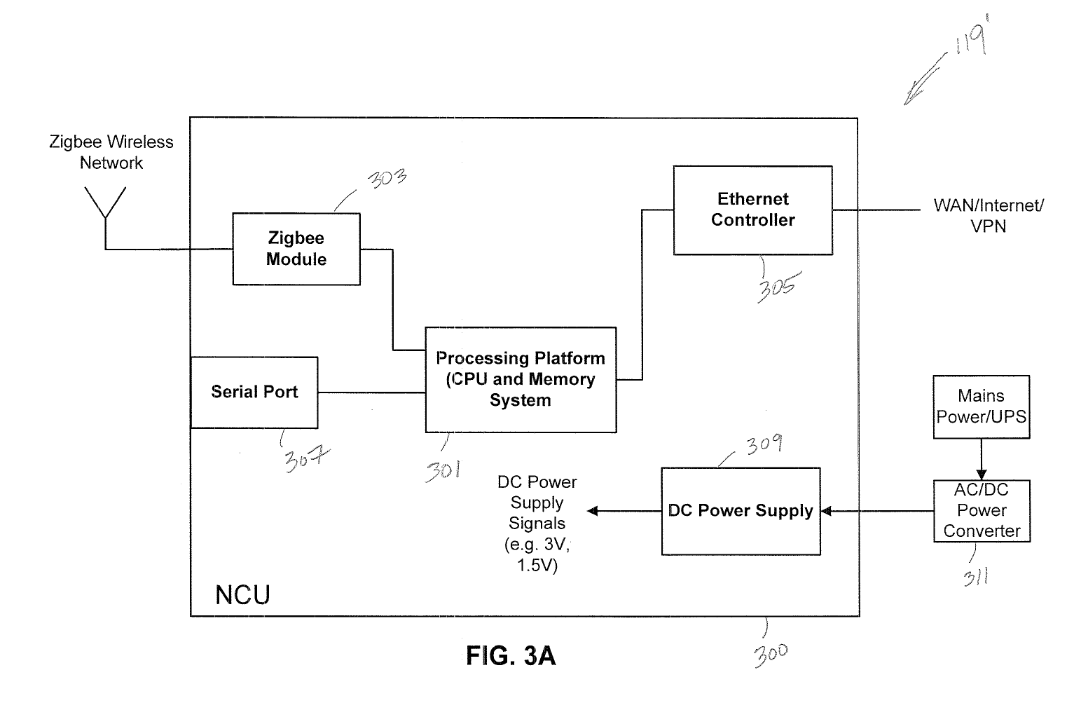

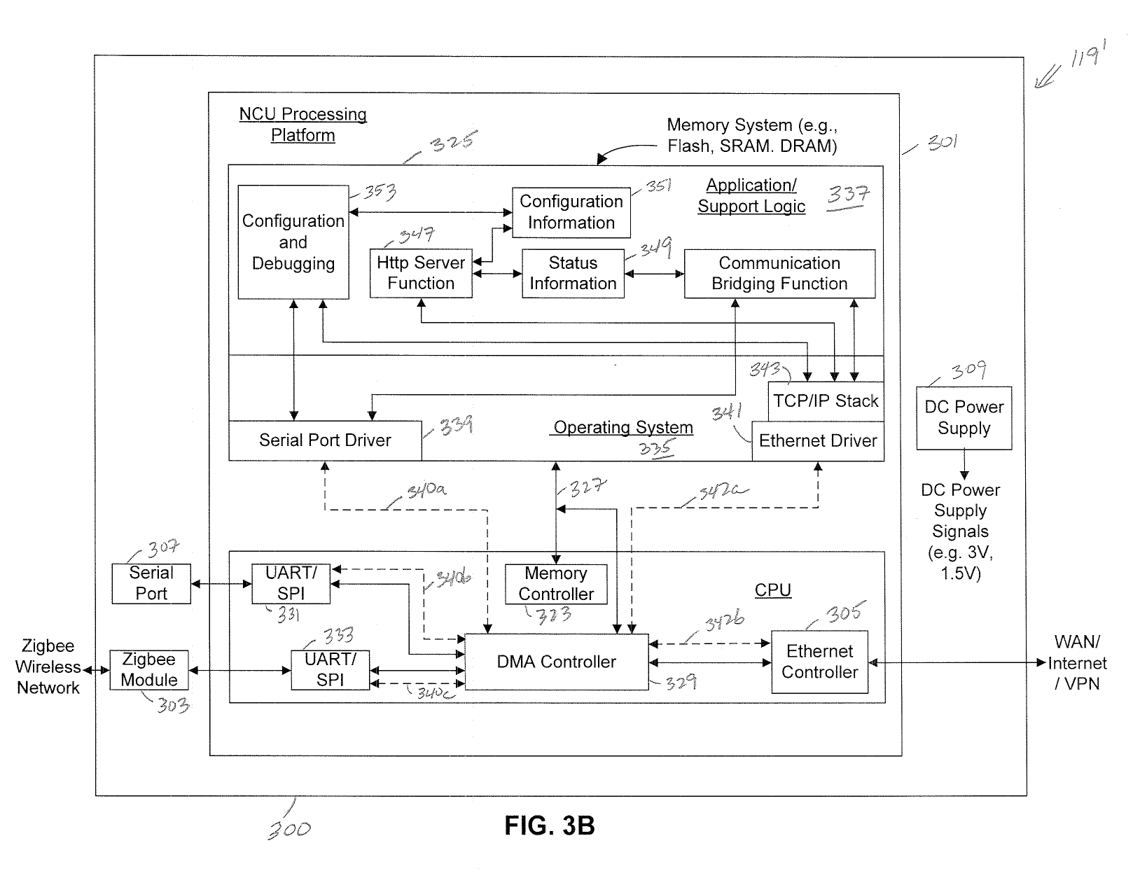

FIG. 3A illustrates an exemplary embodiment of the NCU (labeled 119′) of FIG. 1, including a system housing or enclosure 300 that supports a processing platform 301 (i.e., a computer processing unit and a memory system), a wireless communication interface 303, a network controller 305, a serial port 307, and a DC power supply circuit 309. These elements are preferably mounted on one or more printed circuit boards (not shown) with interconnections therebetween as is standard in the electronic arts, with the circuit board(s) supported and enclosed within the housing 300. The processing platform 301 controls the operation of the NCU 119′ utilizing both hardware resources and software resources contained therein.

The wireless communication interface 303 provides for wireless communication over the local area 102 of the installation site (FIG. 1) utilizing an industry standard wireless communication protocol, which is the same protocol supported by the wireless communication interfaces of local group of TCUs (109A, 109B, 109C, 109D) and the sensor unit 111 to provide for a local wireless network that allows for wireless communication between these devices. In the preferred embodiment, the wireless communication interface 303 supports wireless communication based on the IEEE 802.15.4-2003 protocol such as a Zigbee as shown. The network controller 305, which is preferably realized by a 10 Mbps/100 Mbps Ethernet Controller, provides for communication over a wide area network (such as the Internet/VPN) utilizing a standard networking protocol (preferably TCPIP) that connects the NCU 119′ to the remote system(s) (SCADA system 121 and/or the remote monitoring station(s) 123).

The DC power supply unit 309 performs DC/DC power conversion that converts DC power signals generated by an external AC/DC power converter 311 into regulated DC power signals at the levels (e.g., 3V and 1.5V) required for supply to the active components of the unit. The AC/DC power converter 311 (e.g., a switched-mode power supply) is supplied with AC power signals from Mains electricity (or an Uninterruptable Power Supply) 313, and converts such AC power signals into DC power signals suitable for input to the DC power supply unit 309.

The serial port 307 provides for serial communication between an external device (e.g., a laptop computer or other suitable device) and the processing platform 301 of the NCU 119′ for debugging purposes.

FIG. 3A is a functional block diagram illustrating the hardware resources and software resource of the processing platform 301 of the exemplary NCU 119′ of FIG. 3A. The hardware resources include a computer processing unit (CPU) 321 with an integrated memory controller 323 that is coupled to a memory system 325 by a bus 327. The memory controller 323 manages the flow of data going to and from the memory system 325 over the bus 327. The memory system 325 can be realized by one or more memory devices, which can be the same or different types of memory devices such as Flash memory devices (for persistent storage), SRAM devices, DRAM devices. The CPU 321 further includes an integrated DMA controller 329 that interfaces to the memory system by bus 327. The DMA controller 329 operates under control of the CPU 321 to move blocks of data between the memory system 325 and a plurality of integrated peripheral devices (including a first UART/SPI interface 331, a second UART/SPI interface 333, and an Ethernet controller module 305). The First UART/SPI interface 331 is configured as a serial interface to provide the serial port 307 of the device. The second UART/SPI interface 333 is configured as a serial interface to the wireless network interface 303 (Zigbee module) of the system.

The software resources of the system are embodied in the memory system 325. The software resources are stored in a persistent manner as part of the memory system 325 (for example, in Flash memory devices of the memory system 325) and loaded into non-persistent memory (for example, SRAM and/or DRAM devices of the memory system 325) during startup for execution by the CPU 321. The software resources include an operating system 335 as well as application/support logic 337. The operating system 335 manages the hardware resources of the system, and provides common services for execution of the application/support logic 337. For certain functions such as input and output and memory allocation, the operating system 335 acts as an intermediary between the application/support logic 337 and the hardware resources of the CPU 321. The application/support logic 337 is usually executed directly by the CPU 321 and can frequently call the operating system 335 or be interrupted by it.

The operating system 335 includes a kernel that provides the most basic level of control over the hardware resources of the CPU 321. Execution of the application and support logic 337 involves the creation of processes by the operating system 335. The kernel creates a process by assigning memory and other resources, establishing a priority for the process (in multi-tasking systems), loading program code into memory, and executing the program. The program then interacts with the other devices and performs its intended function. As part of these operations, the kernel manages memory access for the processes, it determines which processes get access to which hardware resources, it sets up or resets the CPU's operating states for optimal operation at all times, and it organizes the data for persistent storage (such as in the Flash memory device of the memory system 325). The operating system 335 also provides additional services that can be used in the execution of the application and support logic 337. Such additional services typically include Multiple Modes of operation (e.g., Supervisor Mode for low level tasks of the kernel that need unrestricted access to the hardware resources of the CPU, and Protected Mode for other tasks of the operating system with limited access to the hardware resources of the CPU); Interrupt Handling Services (Interrupts provide an efficient way for the operating system to interact with and react to its environment); Security Services for authenticating users and managing access to the resources of the system by users; Device Drivers (which is a specific type of computer software developed to allow interaction with particular hardware devices); and Networking Services that support standardized networking protocols that allow for communication with other systems.

In the illustrative embodiment of FIG. 3B, the operating system 335 includes a serial port device driver 339 and a network controller driver 341. The serial port driver provides a logical interface to the UART/SPI 331 (as depicted by arrows 340a and 340b) for the serial port 307 as well as a logical interface to the UART/SPI 333 (as depicted by arrows 340a and 340c) for the wireless communication interface 303 (Zigbee module). The network controller driver 341 provides a logical interface to the integrated network controller 305 (as depicted by arrows 322a and 322b). In the preferred embodiment, these logical connections are realized by transfer of data between the memory system 325 and the respective peripheral device via the DMA controller 329 as is well know in the art. The operating system 325 also includes a TCP/IP stack 343, which embodies a set of communications protocols used for the Internet and other similar networks. It is named from two of the most important protocols in it: the Transmission Control Protocol (TCP) and the Internet Protocol (IP). The protocols of the TCP/IP stack 343 cooperate with the network controller device driver 341 and the Network controller 305 logically connected thereto to provide for communication over the wide area network to the remote system(s) (the SCADA system 121 and/or the remote management station(s) 123) of FIG. 1.

The Application/support logic 337 includes a communication bridging function 345 that interfaces to the TCP/IP stack 343 and the Serial port driver 339 of the operating system 335. The communication bridging function 345 provides gateway functionality between the remote system(s) and the local group of TCUs (109A, 109B, 109C, 109D) and the sensor unit 111 on the local wireless network. In the preferred embodiment, such gateway functionality includes receiving information (including an identifier or address for the respective TCU or the sensor unit) extracted from TCP/IP packed data addressed to the NCU 119 from the remote system, building an NWK Layer Frame that encapsulates the extracted information in a format suitable for consumption by the respective TCU or the sensor unit 111 (with a destination network address corresponding to the respective TCU or sensor unit as referred to by the identifier or address extracted by the NCU), and then forwarding the NWK Layer Frame to the Zigbee module 303 (via the serial port driver 339) for initiating communication of the Zigbee message over the Zigbee network using the most appropriate path in the network. The gateway functionality of the communication bridging function 345 also preferably includes receiving an NWK Layer Frame that originates from a respective TCU or the sensor unit and received via the Zigbee module 303 via the serial port driver 339. This NWK Layer Frame can include an identifier or address for the remote system. In this case, the bridging function 345 cooperates with the TCPIP stack 343 to generate TCP/IP pack data that encapsulates the received NWK Layer Frame and is addressed to the remote system for delivery thereto via the Ethernet driver 341 and Ethernet controller 305.

The Application/Support logic 337 also preferably incorporates an HTTP server 347 (and possibly other web services logic) that allows for interaction between the NCU 119′ and the remote system(s) (the SCADA system 121 and/or the remote management station 123) to provide for remote access to status information 349 stored by the memory system 325 as well for remote configuration of parameters 351 stored by the memory system 325 by the remote system(s). The status information 349 can include GPS time and location, a wind alarm flag, temperature, voltage level of the power supply unit of the sensor unit and other acquired data communicated from the sensor unit 111. The status information can also include other data communicated from the local group of TCUs (109A, 109B, 109C, 109D) to the NCU 119′ over the local wireless network (e.g., the Zigbee network). The configuration parameters stored in the memory system 325 can include parameters for the wide area network interface of the NCU 119′ (such as the TCPIP address, security-related settings, i.e., a user name and password for authentication, firewall-related settings, and VPN-related settings) as well parameters for the wireless communication network interface of the NCU 119′ (such as channel number, PAN ID, Network Address for the NCU, Endpoint Address for a control application within the NCU, Node type (Coordinator), and a routing table for a Zigbee wireless network). In this configuration, the remote system(s) employ a web browser to access the status information and configuration parameters provided by the HTTP server 347.

The Application/Support Logic 337 also preferably incorporates configuration services 353 (such as telnet) that interface to the TCP/IP stack 343 and provide for remote configuration of the parameters 351 stored by the memory system 325 by the remote system(s). In this configuration, the remote system employs a command line interface (or other suitable interface) to access the configuration functionality provided by the configuration services 353. The configuration services 353 can also interface to the serial port driver 339 such that they are available via the serial port 307 for local configuration. Other suitable services (such as an XML-based remote command interface, SNMP interface, and serialTCP) can be used to provide for remote (and/or local) configuration of the NCU 119′.

In the preferred embodiment, the sensor unit 111 functions to perform a variety of functions that include:

periodically reading GPS time and location data from an internal GPS receiver and communicating such GPS time and location to the NCU 119 via the wireless network interface of the sensor unit 111; the GPS time and location can also be communicated from the sensor unit to a requesting node (e.g., the NCU 119) in response to a request communicated from the requesting node;

deriving a measure of wind speed based on the output of an external anemometer, raising an alarm in the event that the measured wind speed exceeds a predetermined threshold (preferably dictated by configuration of the sensor unit 111), and communicating such alarm to the NCU 119 via the wireless network interface of the sensor unit 111; and

possibly acquiring data from other local sensors, and communicating such acquired data to the NCU 119 via the wireless network interface of the sensor unit 111; such data can also be communicated from the sensor unit to a requesting node (e.g., the NCU 119) in response to a request communicated from the requesting node.

The NCU 119 can operate to store the information communicated from the sensor unit 111 (e.g., GPS time and location, wind alarm flag, temperature, voltage level of the power supply unit of the sensor unit and other acquired data) preferably as part of status information stored by the memory system of the NCU (FIG. 3B). The NCU 119 can also operate to propagate such information (or messages derived therefrom) to the local group of TCUs (109A, 109B, 109C, 109D). The NCU 119 can propagate the information (or messages derived therefrom) as part of unicast messages directed to the local group of TCUs utilizing routing information for the local group of TCUs stored at the NCU 119 as described above. The unicast messages can employ source routing information to avoid the overhead of a fully meshed network. Alternatively, the NCU 119 can propagate the information (or messages derived therefrom) to the local group of TCUs utilizing logical connections defined by bindings as described above. In another alternative, the NCU 119 can propagate the information (or messages derived therefrom) to the local group of TCUs utilizing the broadcast (multicast) mechanism to its child nodes by employing a destination network address of 0xfffd (or 0xfffd) as described above. Router nodes that receive the broadcast can also repeat the broadcast. In this manner, the information propagates to the local group of TCUs (109A, 109B, 109C, 109D).

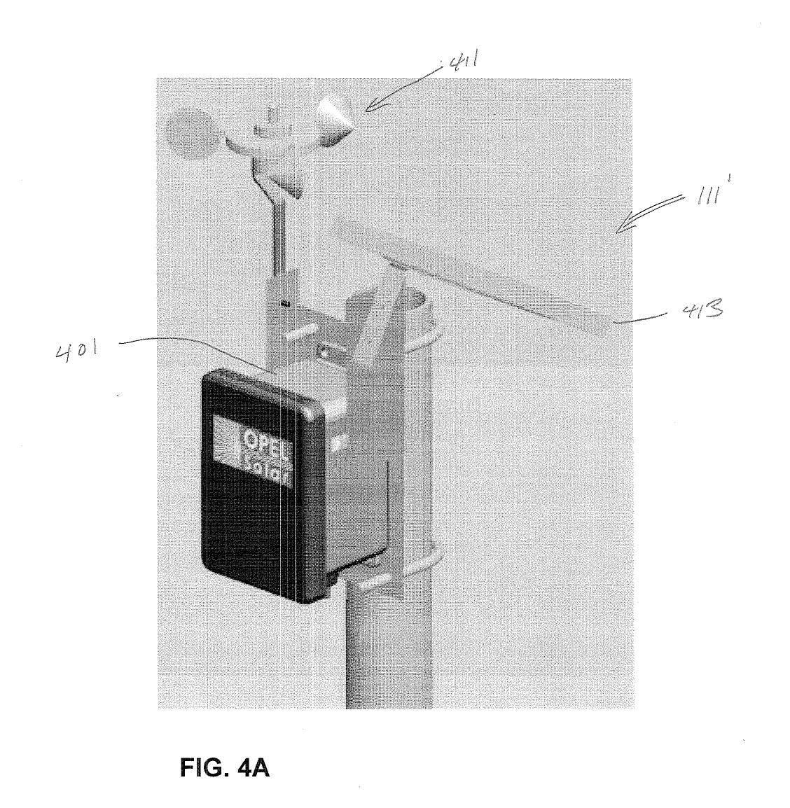

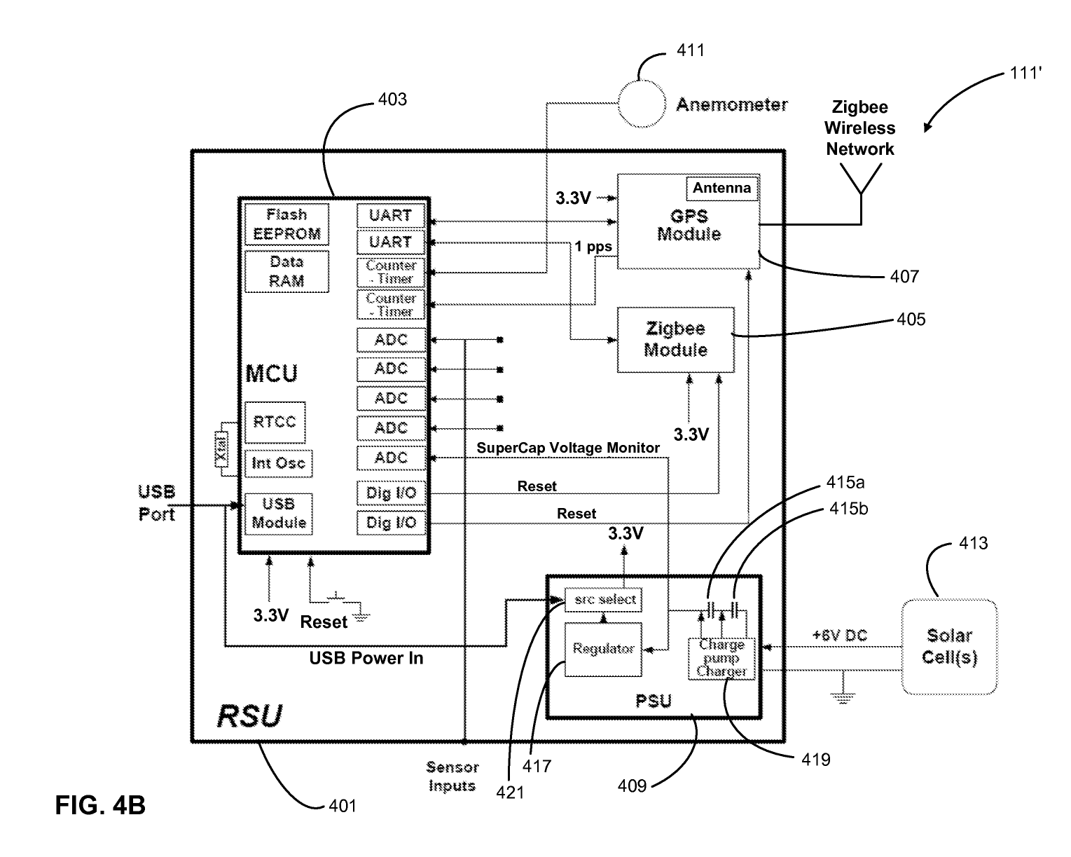

An exemplary embodiment of a sensor unit 111′ is shown in FIGS. 4A and 4B. The sensor unit 111′ includes a system enclosure 401 that houses a low power microcontroller 403, a wireless communication interface 405 (Zigbee module), an internal GPS receiver module 407, and a power supply unit 409. The low power microcontroller 403 interfaces to the wireless communication interface 405 and a plurality of sensors (including the internal GPS receiver module 407, an external anemometer 411 and possibly other external sensors (not shown)). The power supply unit 409 interfaces to one or more external solar cell(s) 413. The enclosure 401 can be secured to a bracket suitable for pole mounting, and the anemometer 411 and the solar cell 413 can be supported by the bracket in close proximity to the enclosure 401 as shown in FIG. 4A.

In the preferred embodiment, the low power microcontroller 403 includes internal program memory and data memory, a real time clock, a plurality of analog-to-digital converter (ADC) ports for interfacing to sensor inputs, a number of timer-counters (including a set of timer-counters interfaced to the anemometer for measuring wind speed), at least two UARTS, and an USB port for configuration purposes. An external crystal is required to support the real-time clock functionality. One UART provides for serial communication to the internal wireless receiver module 405. The other UART provides for serial communication to the internal GPS receiver module 407 (preferably utilizing an NMEA 0183 protocol stack for such serial communication).

The GPS receiver module 407 has circuitry that calculates the position of the unit 111′ by precisely timing the signals sent by GPS satellites high above the Earth. It also calculates a standard GPS time typically with accuracy on the order of 14 ns. The standard GPS time is related to the standard International Atomic Time (TAI) by a predetermined offset. The standard International Atomic Time is the basis for Coordinated Universal Time (UTC), which is the time standard by which the world regulates clocks and time. Thus, the standard GPS time can readily be converted to UTC. In the preferred embodiment, the GPS receiver module 407 includes an integral antenna, a UART (preferably with an NMEA 0183 protocol stack) for serial communication to the microcontroller 403, a reset input, and means for triggering low power mode. The low power mode can be triggering by issuing a specific command for a low power hibernation mode over the serial connection between the microcontroller 403 and the GPS receiver module 407. Alternatively, the microcontroller 403 can apply predetermined signals to a pin of the GPS receiver module 407 for such purposes. In the low power mode, the GPS receiver module 407 has reduced power consumer. For much of the time in this low power mode, the GPS receiver module 407 is incapable of receiving the RF signals from the GPS satellites as its radio is turned off. Periodically (e.g., about once every 2 hours), the radio can be activated and the GPS receiver module 407 calculates its position and time from the GPS satellites. GPS time and date can be requested by the microcontroller 403 issuing a ZDA command over the serial connection between the microcontroller 403 and the GPS receiver module 407. The GPS time returned from the GPS receiver module 407 can be converted to UTC and compared to the time provided by the real time clock maintained by the microcontroller 403. Drift of the real time clock maintained by the microcontroller 403 can be compensated for by time synchronization with the time output of the GPS receiver module 407. Position (Latitude and Longitude) as well as status can be requested by the microcontroller 403 issuing a GLL command over the serial connection between the microcontroller 403 and the GPS receiver module 407. The GPS receiver module 407 preferably includes an integral antenna so that no external antenna is required. A mechanical opening in the system enclosure 401 that leads to the antenna of the GPS receiver module 407 may be used to avoid attenuation of the GPS RF signals, if needed.

The wireless communication interface 405 of the sensor unit 111′ supports wireless communication over a local area of the installation site and can be controlled to operate in one or more low power modes (with reduced power consumption). In the preferred embodiment, the wireless communication interface 405 supports wireless communication based on the IEEE 802.15.4-2003 protocol such as Zigbee. Preferably, the wireless interface includes an RF Transmitter and RF Receiver, a UART, an embedded controller, and means for triggering a low power mode (e.g., Sleep_RQ pin 9).

In the preferred embodiment, the sensor unit 111′ sends unsolicited messages to the NCU 119. Such messages are constructed by the microcontroller 403 and forwarded to the wireless communication interface 405 over the serial connection therebetween for transmission on the local wireless network to the NCU 119. Such unsolicited messages can carry information that indicates that the sensor unit 111′ is active and ready for communication with the NCU. Upon receiving an unsolicited message at the NCU, a request and response protocol is used to convey information between the NCU 119 and the sensor unit 111′. Requests transmitted by the NCU 119 to the sensor unit 111′ are received at the wireless communication interface 405 and forwarded to the microcontroller 403 over the serial connection therebetween for processing. Such requests can involve commands for configuration of the sensor unit 111′ (for example, setting the units (mph or km/hr) for the wind speed measurement, the threshold wind speed for triggering the wind speed alarm, units for voltage measurements for monitoring the charge level of the power supply unit of the sensor unit 111′, and units for temperature measured by the sensor unit 111′). These configuration parameters are stored by the microcontroller 403 and used during its control operations. Such requests can also involve requests for status data (e.g., communication status and/or data acquired by the sensor unit 111′, such as GPS time and location, wind alarm flag, temperature, voltage level of the power supply unit of the sensor unit 111′ and other acquired data). The microcontroller 403 derives a response message corresponding to the received request and forwards the response message to the wireless communication interface 405 over the serial connection therebetween for communication over the local wireless network to the NCU 119.

The NCU 119 can operate to store the data communicated from the sensor unit 111′ (e.g., GPS time and location, wind alarm flag, temperature, voltage level of the power supply unit of the sensor unit and other acquired data) preferably as part of status information stored by the memory system of the NCU (FIG. 3B). The NCU 119 can also operate to propagate such information (or messages derived therefrom) to the local group of TCUs (109A, 109B, 109C, 109D). The NCU 119 can propagate the information (or messages derived therefrom) as part of unicast messages directed to the local group of TCUs utilizing routing information for the local group of TCUs stored at the NCU 119 as described above. The unicast messages can employ source routing information to avoid the overhead of a fully meshed network. Alternatively, the NCU 119 can propagate the information (or messages derived therefrom) to the local group of TCUs utilizing logical connections defined by bindings as described above. In another alternative, the NCU 119 can propagate the information (or messages derived therefrom) to the local group of TCUs utilizing the broadcast (multicast) mechanism to its child nodes by employing a destination network address of 0xfffd (or 0xfffd) as described above. Router nodes that receive the broadcast can also repeat the broadcast. In this manner, the information propagates to the local group of TCUs (109A, 109B, 109C, 109D).

The power supply unit 409 supplies DC power supply signals to the components of the sensor unit 111′. It includes one or more rechargeable storage elements 415 for storing electrical energy, and a regulator circuit 417 that converts the electrical energy (charge) stored by the storage element(s) 415 to one or more fixed DC voltage levels for supply to the components of the sensor unit 111′. The power supply unit 409 also includes a DC-DC converter 419 that interfaces to the one or more external solar cell(s) 413. The DC-DC converter 419 converts the DC voltage signals generated by the external solar cell(s) 413 to desired voltage levels for recharging the storage elements 415.

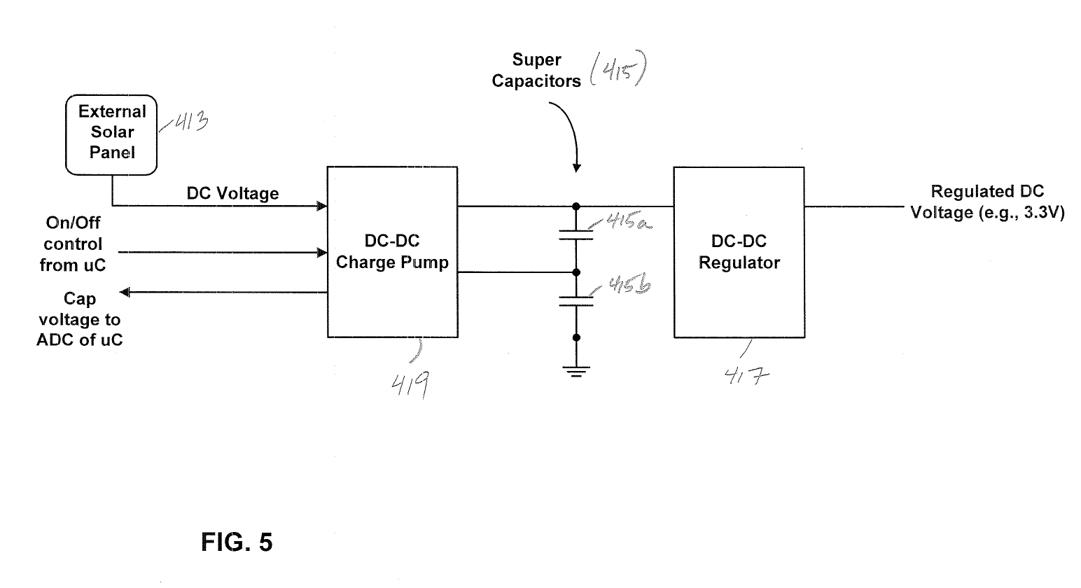

In the preferred embodiment as illustrated in FIG. 5, the rechargeable storage elements 415 are realized by supercapacitors (415a, 415b), the DC-DC converter 419 is realized by a DC-DC charge pump, the regulator circuit 417 is realized by a DC-DC Regulator circuit, and the external solar cell 413 is a single solar panel with a DC output. Alternatively, the storage element(s) 415 can be realized by rechargeable batteries. Optionally, an external battery backup (not shown) can be coupled to the DC-DC converter 419 for backup power in the event that no solar input in available (e.g., at night). As shown in FIG. 4B, the power supply unit 409 can also include source selector logic 421 that is provided with DC power signals (3.3V) from the USB port for supply to the components of the sensor unit 111′ for configuration and debugging purposes (instead of from the output of the regulator as during normal operation).

In the preferred embodiment, the microcontroller 403 includes an analog-to-digital converter (ADC) port that interfaces to the output of the storage elements 415 (e.g., supercapacitors) in order to monitor the voltage level stored by the storage element(s) 415 and perform desired automatic power management operations (i.e., transition sensor unit to Off mode) in the event that the voltage level stored by the storage element(s) 415 is not sufficient to operate the sensor unit 111′.

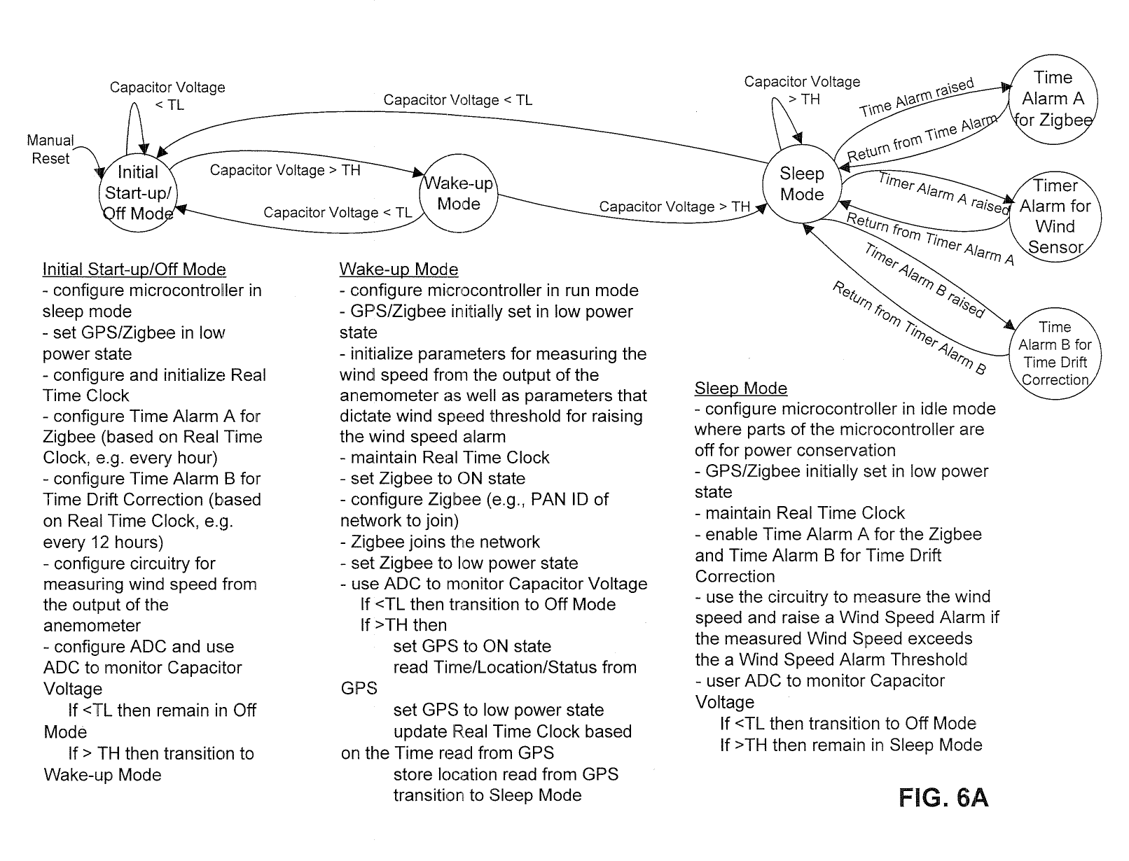

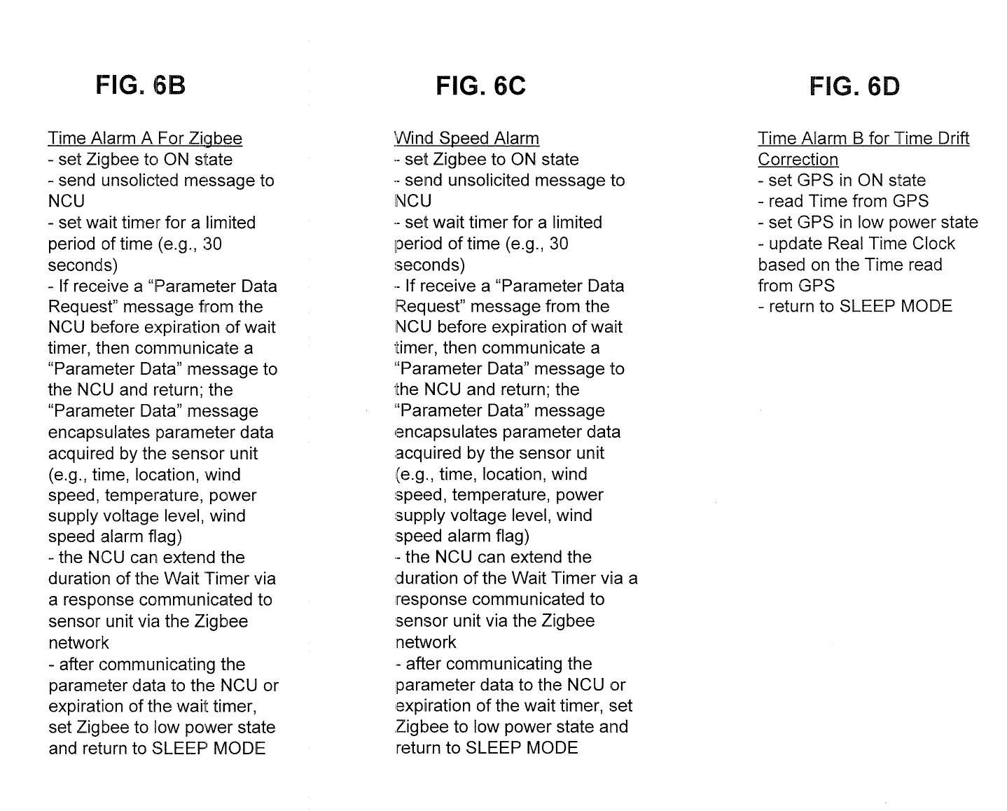

In the preferred embodiment, the microcontroller 403 of the sensor unit 111′ is configured to automatically operate in three modes as shown in FIG. 6A. These operational modes are dictated, at least in part, by the voltage level stored by the storage element(s) 415 of the unit. In each of the three operation modes, the wireless network interface 405 and the GPS receiver module 407 of the sensor unit 111′ operate in a low power state for a majority of time. The wireless network interface 405 is switched into an active state (full power state) under control of the microcontroller 403 only when it is required for communication over the local wireless network. The GPS receiver module 407 is switched into an active state (full power state) under control of the microcontroller 403 only when it is required to provide time and location to the unit.

More specifically, when the microcontroller 403 is started up (by manually pressing a reset button) or when the voltage level stored by the storage element(s) 415 is less than a predetermined low threshold voltage level VL (indicating that the voltage level is not sufficient to operate the sensor unit), the microcontroller 403 operates in an STARTUP/OFF MODE. In this STARTUP/OFF MODE, the microcontroller 403 is initialized in a low power mode for reduced power consumption, and the GPS receiver module 407 and the wireless network interface 405 are set in low power states for reduced power consumption (or the supply of power supply signals to these components can be switched off for reduced power consumption). In the preferred embodiment, the wireless network interface 405 reduces power consumption in its low power state by shutting down its radio. In this configuration, the wireless network interface 405 is incapable of communicating over the wireless network. Similarly, the GPS receiver module 407 can reduce power consumption in its low power state by shutting down its radio. In this configuration, the GPS receiver module 407 is incapable of receiving RF GPS signals from the GPS satellites (i.e., its radio is shut down).

In this STARTUP/OFF MODE, the microcontroller 403 configures and initializes a real time clock (RTC) that is built into the microcontroller 403. A Time Alarm A for the wireless network interface (which is based on the RTC, e.g. every hour) is configured on the microcontroller 403. A Time Alarm B for time drift correction (which is based on the RTC, e.g. every 12 hours) is configured on the microcontroller 403. Circuitry for measuring wind speed from the output of the anemometer is also configured on the microcontroller 403. In the preferred embodiment, such circuitry includes a counter for counting pulses generated by rotations of the anemometer, an interrupt for identifying saturation of this pulse counter, and a timer for measuring elapsed time for a predetermined number of the counter saturation interrupts. In this case, the wind speed can be measured as a function of the predetermined number of interrupts and the elapsed time. Furthermore, the analog-to-digital converter circuitry of the microcontroller 403 is configured and used to monitor the voltage level stored by the storage element(s) 415. If this voltage level is less than the predetermined low threshold voltage level VL (indicating that the voltage level is not sufficient to operate the sensor unit), the microcontroller 3403 remains in the STARTUP/OFF MODE. From Reset, if this voltage level is greater than a predetermined threshold voltage VH (indicating that the voltage level is sufficient to operate the sensor unit), the microcontroller 403 automatically transitions to a WAKE-UP mode.

In the WAKE-UP mode, the microcontroller 403 is configured in a run mode (typically a full power mode), and the GPS receiver module 407 and the wireless network interface 405 are initially operated in low power states for reduced power consumption (which preferably avoids a long startup time). The microcontroller 403 further initializes the parameters for measuring the wind speed from the output of the anemometer as well as the parameters that dictate the wind speed threshold for raising a wind speed alarm. The microcontroller 403 also maintains the RTC. The microcontroller 403 then sets the wireless network interface 405 to an ON (fully operational) state. With the wireless network interface 405 in its ON state, the wireless network interface 405 is capable of communicating over the wireless network (i.e., its radio is activated). The microcontroller 403 can communicate with the wireless network interface 405 for configuration purposes (i.e., setting the PAN ID of the Zigbee network to join), if need be. The wireless network interface 405 can then communicate (preferably with the NCU 119 or other node) to join the network (for example, join the Zigbee network with the PAN ID provided by the microcontroller 403). After joining the network, the microcontroller 403 sets the wireless network interface 405 in its low power state. The analog-to-digital converter circuitry of the microcontroller 403 is then used to monitor the voltage level stored by the storage element(s) 415. If this voltage level is less than the predetermined low threshold voltage level VL (indicating that the voltage level is not sufficient to operate the sensor unit), the microcontroller 403 transitions to the STARTUP/OFF mode as described above. If this voltage level is greater than the predetermined threshold voltage VH (indicating that the voltage level is sufficient to operate the sensor unit), the microcontroller 403 sets the GPS receiver module in an ON (fully operational) state. With the GPS receive module 407 in its ON state, the GPS receiver module 407 is capable of receiving RF GPS signals from the GPS satellites (i.e., its radio is active). The microcontroller 403 then issues commands (e.g., “ZDA” and “GLL” NEMA messages) to request the output of Time (e.g., UTC time), Location, and status (e.g., data valid or invalid) from the GPS receiver module 407 and waits for output of such data (preferably with data valid status) from the GPS receiver module 407. After receiving valid data output from the GPS receiver module, the microcontroller 403 updates its RTC such that it is synchronized with the time data provided by the GPS receiver module 407. The microcontroller 403 also stores the location provided by the GPS receiver module 407, sets the GPS receiver module 407 into its low power state, and then automatically transitions to a SLEEP MODE as described below.

In the SLEEP mode, the microcontroller 403 is configured in a low power mode (such an idle mode where parts of the microcontroller 403, such as the CPU, are shut down for power savings but other parts, such as the peripherals, continue to operate), and the GPS receiver module 407 and the wireless network interface 405 are initially operated in low power states for reduced power consumption (which preferably avoid long startup time for the respective modules). The microcontroller 403 also maintains its RTC. Furthermore, the microcontroller 403 enables the Time Alarm A for the wireless network interface (e.g., raised periodically such as every hour in the SLEEP mode), and the Time Alarm B for Time Drift Correction (raised periodically such as every 12 hours in the SLEEP mode). The circuitry for measuring wind speed is used to periodically derive a measure of wind speed. Each wind speed measurement is evaluated to determine if it exceeds the wind speed threshold for raising a wind speed alarm (preferably set by configuration of the sensor unit 111). If so, the microcontroller 403 raises a Wind Speed Alarm. These alarms are preferably serviced by the microcontroller 403 as interrupts and involve the operations described below with respect to FIGS. 6B, 6C and 6D. Furthermore, the analog-to-digital converter circuitry of the microcontroller 403 is used to monitor the voltage level stored by the storage element(s) 415. If this voltage level is less than the predetermined low threshold voltage level VL (indicating that the voltage level is not sufficient to operate the sensor unit), the microcontroller 403 transitions to the STARTUP/OFF MODE as described above. If this voltage level is greater than a predetermined threshold voltage VH (indicating that the voltage level is sufficient to operate the sensor unit), the microcontroller 403 remains in the SLEEP mode.

FIG. 6B illustrates the operations carried out by the microcontroller 403 in servicing the Time Alarm A for the wireless network interface 405 (e.g., raised periodically such as every hour in the SLEEP mode). More specifically, the microcontroller 403 sets the wireless communication interface 405 into an ON (fully operational) state. With the wireless network interface 405 in its ON state, the wireless network interface is capable of communicating over the wireless network (i.e., its radio is activated). The microcontroller 403 then communicates with the wireless communication interface 405 to transmit an unsolicited message to the NCU 119 over the local wireless communication network. The unsolicited message carries information that indicates that the sensor unit 111′ is active and ready for communication with the NCU 119. The microcontroller 403 also sets a wait timer for a limited period of time (e.g., 30 seconds) and waits for a predetermined “Parameter Data Request” message communicated from the NCU 119 via the wireless network interface 405. If the “Parameter Data Request” message is received before expiration of the wait timer, the parameter data acquired by the sensor unit 111′ (e.g., time, location, wind speed, temperature, power supply voltage level, wind speed alarm flag) is encapsulated as part of a “Parameter Data” message that is transmitted to the NCU 119 via the wireless network interface 405. The response from the NCU 119 can also request extension of the duration of the wait timer in order to allow for further communication between the sensor unit 111′ and the NCU 119. After successful communication of the “Parameter Data” message to the NCU 119 or the expiration of the wait timer, the microcontroller 403 sets the wireless network interface 405 into its low power state and returns to the SLEEP MODE processing.

FIG. 6C illustrates the operations carried out by the microcontroller 403 in servicing the Wind Speed Alarm. More specifically, the microcontroller 403 sets the wireless communication interface 405 into an ON (fully operation) state, and then communicates with the wireless communication interface 405 to transmit an unsolicited message to the NCU 119 over the local wireless communication network. The unsolicited message carries information that indicates that the sensor unit 111′ is active and ready for communication with the NCU 119. The microcontroller 403 also sets a wait timer for a limited period of time (e.g., 30 seconds) and waits for a predetermined “Parameter Data Request” message communicated from the NCU 119 via the wireless network interface 405. If the “Parameter Data Request” message is received before expiration of the wait timer, the parameter data acquired by the sensor unit 111′ (e.g., time, location, wind speed, temperature, power supply voltage level, wind speed alarm flag) is encapsulated as part of a “Parameter Data” message that is transmitted to the NCU 119 via the wireless network interface 405. In this case, the wind speed alarm flag encapsulated in the “Parameter Data” message is set to provide an indication that the sensor unit 111 has raised a wind speed alarm. The response from the NCU 119 can also request extension of the duration of the wait timer in order to allow for further communication between the sensor unit 111′ and the NCU 119. After successful communication of the “Parameter Data” message to the NCU 119 or the expiration of the wait timer, the microcontroller 403 sets the wireless network interface 405 into its low power state and returns to the SLEEP MODE processing.

FIG. 6D illustrates the operations carried out by the microcontroller 403 in servicing the Time Alarm B for Time Drift Correction (raised periodically such as every 12 hours). More specifically, the microcontroller 403 sets the GPS receiver module in an ON (fully operational state). With the GPS receive module 407 in its ON state, the GPS receiver module 407 is capable of receiving RF GPS signals from the GPS satellites (i.e., its radio is active). The microcontroller 403 then issues commands (e.g., “ZDA” and “GLL” NEMA message) to request the output of Time (e.g., UTC time), Location, and status (e.g., data valid or invalid) from the GPS receiver module 407 and waits for output of such data (preferably with data valid status) from the GPS receiver module 407. After receiving valid data output from the GPS receiver module 405, the microcontroller 403 updates its RTC such that it is synchronized with the time data provided by the GPS receiver module 407. After synchronization of the RTC is complete, the microcontroller 403 sets the GPS receiver module 407 into its low power state and returns to the SLEEP MODE processing.

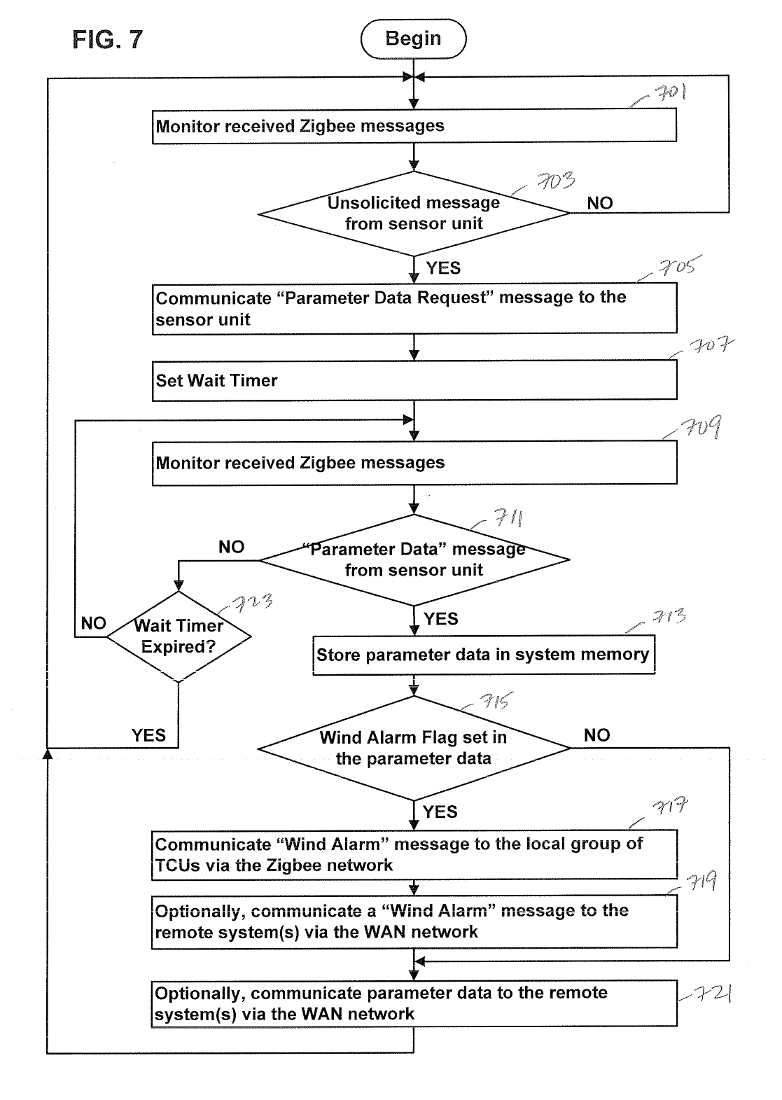

FIG. 7 illustrates exemplary operations carried out by the NCU 119 in communicating with sensor unit 111′ as well as the local group of TCUs (109A, 109B, 109C, 109D) and the remote system(s) during the alarm conditions of FIGS. 6B and 6C.

The operations begin in step 701 where the processing platform of the NCU 119 monitors the messages received at the wireless network interface 303 of the NCU 119. In step 703, the processing platform of the NCU 119 checks whether the received message is an unsolicited message communicated from the sensor unit 111 (preferably by checking that the source network address of the unsolicited message matches the network address assigned to the sensor unit 111). If the check of step 703 passes, the operations continue to step 705; otherwise the operations return to step 701 for suitable message processing and continued monitoring of received messages.

In step 705, the processing platform of the NCU 119 builds a message for communication to the sensor unit 111 by the wireless network interface 303. This message conveys a request for parameter data acquired by the sensor unit 111. For the sake of description, this message is referred to as a “Parameter Data Request” message herein. The Parameter Data Request message is then supplied to the wireless network interface 303 of the NCU 119 for communication to the sensor unit 111.

In step 707, the processing platform of the NCU 119 sets a wait timer for a limited period of time (e.g., 30 seconds).

In steps 709 and 711, the processing platform of the NCU 119 monitors the messages received at the wireless network interface 303 of the NCU 119 and checks whether the received message is a message communicated from the sensor unit 111 that conveys parameter data acquired by the sensor unit 111. For the sake of description, this message is referred to as a “Parameter Data” message herein. The parameter data can include GPS time and location, a wind alarm flag, temperature, voltage level of the power supply unit of the sensor unit and other data acquired by the sensor unit 111. If the check of step 711 passes, the operations continue to step 713; otherwise the operations continue to step 723 to monitor expiration of the wait timer.

In step 713, the processing platform of the NCU 119 stores the parameter data conveyed in the Parameter Data message in the system memory of the NCU 119 and continues to step 715.

In step 715, the processing platform of the NCU 119 checks whether the wind alarm flag is set in the parameter data conveyed in the Parameter Data message. If the check of step 715 passes, the operations continue to step 717; otherwise the operations continue to step 721.

In step 717, the processing platform of the NCU 119 builds one or more messages for communication to the local group of TCUs (109A, 109B, 109C, 109D) via the wireless network interface 303. These messages convey a wind alarm condition as determined by the sensor unit 111. For the sake of description, these messages are referred to as a “Wind Alarm” messages herein. The Wind Alarm message(s) is (are) supplied to the wireless network interface 303 for communication to the local group of TCUs. The local group of TCUs are programmed to perform stow operations at the tracker devices upon reception of a respective Wind Alarm message as described herein. The Wind Alarm messages can be unicast messages directed to the local group of TCUs utilizing routing information for the local group of TCUs stored at the NCU 119 as described above. The unicast messages can employ source routing information to avoid the overhead of a fully meshed network. Alternatively, the NCU 119 can utilize logical connections defined by bindings as described above to communicate a Wind Alarm message to the local group of TCUs. In another alternative, the NCU 119 can propagate the Wind Alarm message to the local group of TCUs utilizing a broadcast (multicast) mechanism supported by the local wireless, such as by employing a destination network address of 0xfffd (or 0xfffd) in a Zigbee network as described above.

In optional step 719, the processing platform of the NCU 119 builds one or more messages for communication to the remote station(s) via the WAN interface 305. These messages convey a wind alarm condition as determined by the sensor unit 111 for monitoring purposes at the remote station(s). The Wind Alarm message(s) is (are) supplied to the WAN interface 305 for communication to the remote station(s).

In optional step 721, the processing platform of the NCU 119 builds one or more messages for communication to the remote station(s) via the WAN interface 305. These messages convey parameter data as acquired by the sensor unit 111 and stored in step 713 for monitoring purposes at the remote station(s). Such message(s) is (are) supplied to the WAN interface 305 for communication to the remote station(s). After step 721, the operations return to step 701 to continue monitoring the messages received at the wireless network interface 303 as described above.

In step 723, the processing platform of the NCU 119 evaluates the expiration of the wait timer set in step 707. If in step 723 it is determined that the wait timer has not expired, the operations return to step 709 to continue monitoring the messages received at the wireless network interface 303 in order to detect reception of the “Parameter Data” message. On the other hand, if in step 723 it is determined that the wait timer has expired, the operations return to step 701 to continue monitoring the messages received at the wireless network interface 303 as described above.

In an alternate embodiment, the sensor unit 111 can be adapted to operate in a system that does not include the NCU 119 and its gateway functionality. In this configuration, the compatible wireless communication interfaces of the sensor unit 111 and the local group of TCUs (109A, 109B, 109C, 109D) allow for propagation of information from the sensor unit 111 to the local group of TCUs (109A, 109B, 109C, 109D). Such communication preferably provides for propagation of the time as well as location measured by the integral GPS module of the sensor unit 111 to the local group of TCUs (109A, 109B, 109C, 109D) for tracking purposes. Such communication also preferably provides for propagation of a wind speed alarm message from the sensor unit 111 to the local group of TCUs (109A, 109B, 109C, 109D) upon detection of high wind speed alarm condition at the sensor unit 111. The reception of the wind speed alarm message at the respective TCUs can trigger the respective TCUs to automatically orient the corresponding PV systems in a safe position that is desired for high wind loads.

In this embodiment, the sensor unit 111 can be configured as a Zigbee End Device, the local group of TCUs (or a subset thereof) are configured as Zigbee Routers or End Devices), and another node on the Zigbee network (e.g., one of the TCUs) is configured as the Coordinator node on the Zigbee network. The topology of the Zigbee network can be a Star topology, Tree topology or Mesh topology as desired.

In this configuration, the sensor unit 111 can operate to propagate such information (or messages derived therefrom) to the local group of TCUs (109A, 109B, 109C, 109D) as part of unicast messages directed to the local group of TCUs utilizing routing information for the local group of TCUs stored at the sensor unit 111. The unicast messages can employ source routing information to avoid the overhead of a fully meshed network. Alternatively, the sensor unit 111 can propagate such information (or messages derived therefrom) to the local group of TCUs (109A, 109B, 109C, 109D) as described above utilizing the broadcast functionality supported by the Zigbee network. More specifically, the information message can utilize logical connections defined by bindings (or a destination network address of 0xfffd (or 0xfffd), which operates to broadcast (multicast) the information message from the source sensor unit 111 to the local group of TCUs on the Zigbee network.

In yet another alternative embodiment, the systems as described herein can include two or more sensor units 111 that are deployed about the local area of the installation site for redundancy purposes.

Advantageously, the wireless networked sensor apparatus of the present invention can be mounted on a pole (or other structure) at a location best suited for monitoring wind conditions. Moreover, the solar powered power supply unit of the wireless networked sensor apparatus as well as its programmed operations that reduce the load on the solar powered power supply unit allow for operation that does not require the supply of mains power, even during long time periods (e.g., a number of days) with minimal sunlight. Both of these features allow for flexibility in positioning the wireless networked sensor apparatus such that is can provide for more effective monitoring of wind speed. It also reduces the time and costs required to maintain the apparatus, while provided for effecting communication of GPS time and location, wind speed, a wind alarm flag, temperature, voltage level of the power supply unit of the sensor unit and/or other acquired data to the local tracker control units and remote monitoring systems.

There have been described and illustrated herein several embodiments of a wireless networked sensor apparatus (and systems based thereon) for a distributed system for control of a number tracker devices of a PV generation system control. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An apparatus for use in a solar energy facility including a plurality of photovoltaic systems distributed over a local area and a plurality of tracking systems corresponding to the photovoltaic systems that operate to orient the corresponding photovoltaic systems, wherein each tracking system includes a tracking control unit, and wherein the tracking control units of the tracking systems each include a wireless network interface for wireless communication over the local area, the apparatus comprising:
a wireless network interface for wireless communication over the local area;
a plurality of sensors including a GPS receiver and an anemometer;
a microcontroller operably coupled to said wireless network interface and said plurality of sensors of said apparatus;
a power supply unit for supplying DC power signals to said apparatus, said power supply unit including means for storage of electrical energy; and
at least one photovoltaic cell, operably coupled to said power supply unit, for converting solar insolation into DC power supply signals that are supplied to said electrical energy storage means of said power supply unit;
wherein the microcontroller is programmed to operate in a plurality of modes, wherein said plurality of modes include a low power mode where the microcontroller, wireless network interface and the GPS receiver of said apparatus are automatically operated in respective power saving modes in order to reduce load on said power supply unit of said apparatus.

2. An apparatus according to claim 1, wherein:
the apparatus does not draw power from mains electricity.

3. An apparatus according to claim 2, wherein:
in the low power mode said microcontroller is programmed to raise a wind speed alarm based on output of said anemometer.

4. An apparatus according to claim 3, wherein:
said microcontroller is programmed to perform a predetermined sequence of operations in the event that the wind speed alarm has been raised, wherein the sequence of operations includes changing the mode of operation of said wireless network interface of said apparatus to allow for wireless communication over the local area, and using said wireless network interface to wirelessly communicate over the local area a message that conveys an indication that the wind speed alarm has been raised by the apparatus.

5. An apparatus according to claim 4, wherein:
said microcontroller controls said wireless network interface of said apparatus to return back to its power savings mode after completing said predetermined sequence of operations.

6. An apparatus according to claim 3, wherein:
said wind speed alarm is represented by an interrupt.

7. An apparatus according to claim 3, wherein:
in the low power mode said microcontroller is programmed to derive a measure of wind speed based on the output of said anemometer, and evaluate the measure of wind speed in order to determine whether to raise said wind speed alarm.

8. An apparatus according to claim 7, wherein:
in the low power mode said microcontroller is the programmed to raise said wind speed alarm in the event that the measure of wind speed exceeds a predetermined threshold.

9. An apparatus according to claim 2, wherein:
in the low power mode said microcontroller is programmed to monitor status of a first time alarm.

10. An apparatus according to claim 9, wherein:
said microcontroller is programmed to perform a predetermined sequence of operations in the event that the status of the first time alarm provides an indication that the first time alarm has been raised, wherein the sequence of operations includes
i) changing the mode of operation of said wireless network interface of said apparatus to allow for wireless communication over the local area; and
ii) using said wireless network interface to wirelessly communicate a predetermined message over the local area to provide an indication that the wireless network interface of the apparatus is active and ready for communication.

11. An apparatus according to claim 10, wherein:
said microcontroller controls said wireless network interface to return back to its power saving mode after completing said predetermined sequence of operations.

12. An apparatus according to claim 1, wherein:
said microcontroller of the apparatus maintains a real time clock; and
for at least a majority of the time that said GPS receiver is operated in its power saving mode, said GPS receiver is incapable of receiving RF signals from GPS satellites.

13. An apparatus according to claim 12, wherein:
in the low power mode said microcontroller is programmed to monitor status of a second time alarm.

14. An apparatus according to claim 13, wherein:
said microcontroller is programmed to perform a predetermined sequence of operations in the event that the status of the second time alarm provides an indication that the second time alarm has been raised, wherein the sequence of operations includes
i) changing the mode of operation of said GPS receiver of said apparatus to allow for deriving time from RF signals received from GPS satellites, and
ii) reading time from said GPS receiver of said apparatus; and
iii) updating said real time clock maintained by said microcontroller based upon the time read from said GPS receiver in order to compensate for drift of said real time clock.

15. An apparatus according to claim 14, wherein:
said microcontroller controls said GPS receiver to return back to its power saving mode after completing said predetermined sequence of operations.

16. An apparatus according to claim 1, further comprising:
an enclosure that houses at least said microcontroller, said power supply unit, said GPS receiver and at least a portion of said wireless network interface;
wherein said anemometer and said at least one photovoltaic cell are external to said enclosure.

17. An apparatus according to claim 1, wherein:
said wireless network interface of said apparatus supports wireless communication over a wireless mesh network.

18. An apparatus according to claim 1, wherein:
said wireless network interface said apparatus is configured to operate as an end device of a Zigbee wireless network.

19. An apparatus according to claim 1, wherein:
said wireless network interface of said apparatus is configured to support multicast of a respective message to the tracking control units, wherein the multicast is carried out in a transparent manner with respect to the operation of said wireless network interface.

20. An apparatus according to claim 19, wherein:
the respective message carries information selected from the group consisting of: a wind alarm generated by the microcontroller of the apparatus, time maintained by the real time clock of the microcontroller, and location derived from the GPS receiver of the apparatus.

21. A distributed tracking and control system for use in a solar energy farm including a plurality of photovoltaic systems distributed over a local area and a first control unit remotely located from the local area, the tracking and control system comprising:
a second control unit located within the local area and having a network interface for communicating with the first control unit;
a plurality of trackers corresponding to the photovoltaic systems that operate to orient the corresponding photovoltaic systems, wherein each tracker includes a tracking control unit, and wherein the second control unit and the tracking control units of the trackers each include a wireless network interface for wireless communication over the local area; and
a third control unit, separate and distinct from the second control unit and the tracking control units of the trackers, the third control unit including
a wireless network interface for wireless communication over the local area,
a plurality of sensors including a GPS receiver module and an anemometer,
a microcontroller operably coupled to said wireless network interface and said plurality of sensors of said third control unit,
a power supply unit for supplying DC power signals to said third control unit, said power supply unit including means for storage of electrical energy, and
at least one photovoltaic cell, operably coupled to said power supply unit, for converting solar insolation into DC power supply signals that are supplied to said electrical energy storage means of said power supply unit,
wherein the microcontroller is programmed to operate in a plurality of modes, wherein said plurality of modes include a low power mode where the microcontroller, wireless network interface and the GPS receiver of said third control unit are automatically operated in respective power saving modes in order to reduce load on said power supply unit.

22. A system according to claim 21, wherein:
the third control unit does not draw power from mains electricity.

23. A system according to claim 22, wherein:
in the low power mode said microcontroller of said third control unit is programmed to raise a wind speed alarm based on output of said anemometer.

24. A system according to claim 23, wherein:
said microcontroller of said third control unit is programmed to perform a predetermined sequence of operations in the event that the wind speed alarm has been raised, wherein the sequence of operations includes changing the mode of operation of said wireless network interface of said apparatus to allow for wireless communication over the local area, and using said wireless network interface to wirelessly communicate over the local area a message that conveys an indication that the wind speed alarm has been raised by the third control unit.

25. A system according to claim 24, wherein:
said microcontroller controls said wireless network interface of said third control unit to return back to its power savings mode after completing said predetermined sequence of operations.

26. A system according to claim 23, wherein:
said wind speed alarm is represented by an interrupt.

27. A system according to claim 23, wherein:
in the low power mode said microcontroller is programmed to derive a measure of wind speed based on the output of said anemometer, and evaluate the measure of wind speed in order to determine whether to raise said wind speed alarm.

28. A system according to claim 27, wherein:
in the low power mode said microcontroller is the programmed to raise said wind speed alarm in the event that the measure of wind speed exceeds a predetermined threshold.

29. A system according to claim 22, wherein:
in the low power mode said microcontroller is programmed to monitor status of a first time alarm.

30. A system according to claim 29, wherein:
said microcontroller is programmed to perform a predetermined sequence of operations in the event that the status of the first time alarm provides an indication that the first time alarm has been raised, wherein the sequence of operations includes
i) changing the mode of operation of said wireless network interface of said third control unit to allow for wireless communication over the local area; and
ii) using said wireless network interface of said third control unit to wirelessly communicate a predetermined message over the local area to provide an indication that the wireless network interface of the third control unit is active and ready for communication.

31. A system according to claim 30, wherein:
said microcontroller controls said wireless network interface of the third control unit to return back to its power saving mode after completing said predetermined sequence of operations.

32. A system according to claim 21, wherein:
said microcontroller of the third control unit maintains a real time clock; and
for at least a majority of the time that the GPS receiver of the third control unit is operated in its power saving mode, the GPS receiver of the third control unit is incapable of receiving RF signals from GPS satellites.

33. A system according to claim 32, wherein:
in the low power mode said microcontroller is programmed to monitor status of a second time alarm.

34. A system according to claim 23, wherein:
said microcontroller is programmed to perform a predetermined sequence of operations in the event that the status of the second time alarm provides an indication that the second time alarm has been raised, wherein the sequence of operations includes
i) changing the mode of operation of said GPS receiver of said third control unit to allow for deriving time from RF signals received from GPS satellites, and
ii) reading time from said GPS receiver of said third control unit; and
iii) updating said real time clock maintained by said microcontroller based upon the time read from said GPS receiver in order to compensate for drift of said real time clock.

35. A system according to claim 34, wherein:
said microcontroller controls said GPS receiver module to return back to its power saving mode after completing said predetermined sequence of operations.

36. A system according to claim 21, wherein:
said third control unit further comprises an enclosure that houses at least said microcontroller, said power supply unit, said GPS receiver, and at least a portion of said wireless network interface; and
wherein said anemometer and said at least one photovoltaic cell are external to said enclosure.

37. A system according to claim 21, wherein:
said wireless network interfaces of said tracking control units, second control unit and third control unit support wireless communication over a wireless mesh network.

38. A system according to claim 21, wherein:
said wireless network interface of said third control unit is configured to operate as an end device of a Zigbee wireless network.

39. A system according to claim 21, wherein:
the wireless network interface of said second control unit is configured to operate as a coordinator of a Zigbee wireless network.

40. A system according to claim 21, wherein:
said wireless network interface of said second control unit is configured to support multicast of a respective message to the tracking control units, wherein the respective message conveys parameter data acquired by the third control unit and communicated to the second control unit.

41. A system according to claim 21, wherein:
the second control unit operates to propagate information acquired by the third control unit (or messages derived thereform) to the tracking control units.

42. A system according to claim 21, wherein:
said second control unit is configured to operate as a gateway for communication between the nodes on the wireless network and the first control unit.

43. A system according to claim 42, wherein:
the second control unit communicates with the first control unit over a wide area network.

44. A system according to claim 43, wherein:
the wide area network includes the Internet.

45. A system according to claim 43, wherein:
the wide area network comprises a VPN connection over the Internet.

46. A system according to claim 21, wherein:
the first control unit comprises a remote SCADA system.

47. A system according to claim 21, wherein:
the first control unit comprises a remote management station.

48. A system according to claim 1, wherein:
the third control unit includes mounting means for mounting the third control unit to a pole.

49. An apparatus according to claim 1, further comprising:
mounting means for mounting the apparatus to a pole.
